(19) United States
(12) Patent Application Publication
(10) Pub. No.: US 2026/0310256 A1
(43) Pub. Date: Oct. 8, 2026

(54) WEARABLE ELECTRONIC DEVICE AND METHOD FOR OPERATING SAME

(71) Applicant: Samsung Electronics Co., Ltd., Suwon-si (KR)

(72) Inventors: Heejung KIM, Suwon-si (KR); Seunghyuck HEO, Suwon-si (KR)

(21) Appl. No.: 19/676,066

(22) Filed: May 13, 2026

Related U.S. Application Data
(63) Continuation of application No. PCT/KR2024/020891, filed on Dec. 20, 2024.

(30) Foreign Application Priority Data
Dec. 21, 2023 (KR) 10-2023-0188672
Feb. 7, 2024 (KR) 10-2024-0019127

(51) Int. Cl. G06F 1/16; G04G 21/02; G04G 21/08; G06F 3/01; G06F 3/0488

(52) U.S. Cl. CPC G06F 1/163; G04G 21/025; G04G 21/08; G06F 1/165; G06F 1/1681; G06F 1/1692; G06F 3/011; G06F 3/0488

(57) ABSTRACT

A wearable electronic device is provided. The wearable electronic device includes a housing including a first housing structure, a second housing structure connected to the first housing structure, and a third housing structure, a first hinge driving module configured to connect a first side of the first housing structure and the second housing structure such that the first housing structure and the second housing structure are folded and unfolded, a second hinge driving module configured to connect a second side of the first housing structure and the third housing structure such that the first housing structure and the third housing structure are folded and unfolded, a hinge driving unit configured to drive the first hinge driving module and the second hinge driving module, a display arranged in the housing, a sensor module configured to sense an angle between housing structures and to sense a bending curvature of the display, memory including at least one storage media, storing instructions, and at least one processor, including a processing circuit, communicatively coupled to the memory, wherein, the instructions, when executed by the at least one processor individually or collectively, cause the wearable electronic device to detect a state in which the wearable electronic device is worn on a wrist of a user using the sensor module, identify an activity state of the user using the sensor module based on detecting the state in which the wearable electronic device is worn on the wrist of the user, and adjust at least one of the angle between the housing structures and the bending curvature of the display based on a change in the activity state of the user.

### CROSS-REFERENCE TO RELATED APPLICATION(S)

This application is a continuation application, claiming priority under 35 U.S.C. § 365 (c), of an International application No. PCT/KR2024/020891, filed on Dec. 20, 2024, which is based on and claims the benefit of a Korean patent application number 10-2023-0188672, filed on Dec. 21, 2023, in the Ministry of Intellectual Property (MOIP), and of a Korean patent application number 10-2024-0019127, filed on Feb. 7, 2024, in the MOIP, the disclosure of each of which is incorporated by reference herein in its entirety.

### BACKGROUND

### 1. Field

The disclosure relates to a wearable electronic device and an operating method thereof that may adjust wearing of an electronic device (e.g., wearable electronic device, smart watch, smart band) to be loosened or tightened (e.g., adjust fit of wearable electronic device) according to the activity state of a user and external environmental conditions (e.g., temperature, humidity).

### 2. Description of Related Art

An electronic device (e.g., wearable electronic device, smart watch, smart band) is an electronic device that may be worn on a body of a user due to its miniaturization and lightweight. The wearable electronic device is highly portable, which may lead to improving the convenience of use. The wearable electronic device has high proximity to the body of the user, so may be used for a variety of purposes. The wearable electronic device may include a plurality of sensors (e.g., motion sensor, proximity sensor, temperature sensor, and biometric sensor) to measure a state in which the wearable electronic device is worn on the body of the user (e.g., whether it is worn) and the user's movement and biometric information. The wearable electronic device may use sensors to identify proximity (or contact) to the body, and may determine whether the wearable device is worn and the movement of the user.

The above information is presented as background information only to assist with understanding of the disclosure. No determination has been made, and no assertion is made, as to whether any of the above might be applicable as prior art with regard to the disclosure.

### SUMMARY

A flexible display may be applied to an electronic device (e.g., wearable electronic device, smart watch). The electronic device (e.g., wearable electronic device, smart watch) may be formed to wrap around at least a portion of the wrist of a user. The user may execute a function by touching a display (e.g., screen) of the electronic device (e.g., wearable electronic device, smart watch). Depending on the user's activity state (e.g., sleep, rest, exercise, swimming), the fit required by the user may vary. To adjust the fit of the electronic device (e.g., wearable electronic device, smart watch), the user may directly reduce or extend the length of a strap (e.g., band).

Aspects of the disclosure are to address at least the above-mentioned problems and/or disadvantages and to provide at least the advantages described below. Accordingly, an aspect of the disclosure is to provide a wearable electronic device and an operating method thereof that adjust the fit of an electronic device (e.g., wearable electronic device, smart watch, smart band) to be loosened or tightened (e.g., tight) according to the user's activity state (e.g., sleep, rest, exercise, swimming) and external environmental conditions (e.g., temperature, humidity).

Another aspect of the disclosure is to provide a wearable electronic device and an operating method thereof that display a user interface (e.g., content) on a display such that a user intuitively recognizes that the fit of an electronic device (e.g., wearable electronic device, smart watch, smart band) is adjusted.

Another aspect of the disclosure is to provide an electronic device and an operating method thereof that provides a function capable of adjusting the fit of an electronic device (e.g., wearable electronic device, smart watch, smart band) to a default value and then fine-adjusting the fit according to the needs of the user.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first housing structure, a second housing structure connected to the first housing structure, and a third housing structure, a first hinge driving module configured to connect a first side of the first housing structure and the second housing structure such that the first housing structure and the second housing structure are folded and unfolded, a second hinge driving module configured to connect a second side of the first housing structure and the third housing structure such that the first housing structure and the third housing structure are folded and unfolded, a hinge driving unit configured to drive the first hinge driving module and the second hinge driving module, a display arranged in the housing, a sensor module configured to sense an angle between housing structures, and to sense a bending curvature of the display, memory including, at least one storage media, storing instructions, and at least one processor, including a processing circuit, communicatively coupled to the memory wherein the instructions, when executed by the at least one processor individually or collectively, cause the wearable electronic device to detect a state in which the wearable electronic device is worn on a wrist of a user using the sensor module, identify an activity state of the user using the sensor module based on detecting the state in which the wearable electronic device is worn on the wrist of the user, and adjust at least one of the angle between the housing structures and the bending curvature of the display based on a change in the activity state of the user.

In accordance with another aspect of the disclosure, a method of operating a wearable electronic device is provided. The method includes detecting a state in which the wearable electronic device is worn on a wrist of a user using a sensor module, identifying an activity state of the user using the sensor module based on detecting the state in which the wearable electronic device is worn on the wrist of the user, and adjusting at least one of an angle between housing structures and a bending curvature of a display based on a change in the activity state of the user.

In accordance with another aspect of the disclosure, one or more non-transitory computer-readable storage media storing one or more computer programs including computer-executable instructions that, when executed by at least one processor of a wearable electronic device individually or collectively, cause the wearable electronic device to perform operations are provided. The operations include detecting a state in which the wearable electronic device is worn on a wrist of a user using a sensor module, identifying an activity state of the user using the sensor module based on detecting the state in which the wearable electronic device is worn on the wrist of the user, and adjusting at least one of an angle between housing structures and a bending curvature of a display based on a change in the activity state of the user.

A wearable electronic device and an operating method thereof according to an embodiment of the disclosure display a user interface (e.g., content) on a display such that a user intuitively recognizes that the fit of an electronic device (e.g., wearable electronic device, smart watch, smart band) is adjusted.

A wearable electronic device and an operating method thereof according to an embodiment of the disclosure provide a function capable of adjusting the fit of an electronic device (e.g., wearable electronic device, smart watch, smart band) to a default value and then fine-adjusting the fit according to the needs of the user.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A illustrates a wearable electronic device (e.g., wearable electronic device, smart watch, smart band) according to an embodiment of the disclosure;

FIG. 2B illustrates a housing and a hinge of an electronic device (e.g., wearable electronic device, smart watch, smart band) according to an embodiment of the disclosure;

FIG. 3A is a block diagram of an electronic device (e.g., wearable electronic device, smart watch, smart band) according to an embodiment of the disclosure;

FIG. 3B is a view observed from a rear surface (e.g., surface that comes into contact with wrist) of an electronic device (e.g., wearable electronic device, smart watch, smart band) according to an embodiment of the disclosure;

FIG. 4 is a block diagram of a display module illustrated in FIG. 3A according to an embodiment of the disclosure;

FIG. 5 illustrates an example of adjusting the tightness degree (e.g., loosening or tightening) when an electronic device (e.g., wearable electronic device, smart watch, smart band) is worn on the wrist of a user according to an embodiment of the disclosure;

FIG. 6 illustrates an example of displaying (e.g., visually displaying) through a user interface that the tightness degree (e.g., loosening or tightening) of an electronic device (e.g., wearable electronic device, smart watch, smart band) is adjusted for each situation according to an embodiment of the disclosure;

FIG. 7 illustrates an example of providing a function that allows a user to manually adjust the tightness degree (e.g., loosening or tightening) of an electronic device (e.g., wearable electronic device, smart watch) according to an embodiment of the disclosure;

FIG. 8 illustrates an example of adjusting the tightness degree (e.g., loosening or tightening) of an electronic device (e.g., wearable electronic device, smart watch) due to the change in the angle of a hinge according to an embodiment of the disclosure;

FIG. 9 illustrates an example of adjusting the tightness degree (e.g., loosening or tightening) of an electronic device (e.g., wearable electronic device, smart watch) due to the change in the bending curvature of a sub-display according to an embodiment of the disclosure;

FIG. 10 illustrates an example of adjusting the tightness degree (e.g., loosening or tightening) of an electronic device (e.g., wearable electronic device, smart watch) due to the change in the angle of a hinge and the change in the bending curvature in a sub-display according to an embodiment of the disclosure;

FIG. 11 is a flowchart illustrating an operating method of an electronic device (e.g., wearable electronic device, smart watch, smart band) according to an embodiment of the disclosure;

FIG. 12 illustrates an example of adjusting the tightness degree (e.g., loosening or tightening) of an electronic device (e.g., wearable electronic device, smart watch) in a sleep mode according to an embodiment of the disclosure;

FIG. 13 illustrates an example of adjusting the tightness degree (e.g., loosening or tightening) of an electronic device (e.g., wearable electronic device, smart watch) in an exercise mode according to an embodiment of the disclosure;

FIG. 14 is a flowchart illustrating an operating method of an electronic device (e.g., wearable electronic device, smart watch, smart band) according to an embodiment of the disclosure;

FIG. 15 illustrates an example of displaying (e.g., visually displaying) through a user interface that the tightness degree (e.g., loosening or tightening) of an electronic device (e.g., wearable electronic device, smart watch, smart band) is adjusted according to an embodiment of the disclosure;

FIG. 16 illustrates an example of providing a fine adjustment menu such that a user may manually fine-adjust the tightness degree (e.g., loosening or tightening) of an electronic device (e.g., wearable electronic device, smart watch) according to an embodiment of the disclosure;

FIG. 17 illustrates an example of storing a fine adjustment value of the tightness degree (e.g., loosening or tightening) of an electronic device (e.g., wearable electronic device, smart watch) applied by a user, and automatically adjusting the tightness degree (e.g., loosening or tightening) of the electronic device (e.g., wearable electronic device, smart watch) using the fine adjustment value under the same conditions according to an embodiment of the disclosure;

FIG. 18 illustrates an example of providing a function capable of releasing the tightness degree (e.g., loosening or tightening) of an automatically adjusted electronic device (e.g., wearable electronic device, smart watch) in a sleep mode according to an embodiment of the disclosure;

FIG. 19 illustrates an example of providing a function capable of releasing the tightness degree (e.g., loosening or tightening) of an automatically adjusted electronic device (e.g., wearable electronic device, smart watch) in an exercise mode according to an embodiment of the disclosure;

FIG. 20 illustrates an example of providing a function capable of releasing the tightness degree (e.g., loosening or tightening) of an automatically adjusted electronic device (e.g., wearable electronic device, smart watch) in a swimming mode according to an embodiment of the disclosure;

FIG. 21 illustrates an example of providing a function capable of releasing the tightness degree (e.g., loosening or tightening) of an automatically adjusted electronic device (e.g., wearable electronic device, smart watch) in a biometric data (e.g., biometric information) measurement mode according to an embodiment of the disclosure;

FIG. 22 is a flowchart illustrating an operating method of an electronic device (e.g., wearable electronic device, smart watch, smart band) according to an embodiment of the disclosure;

FIG. 23 is a flowchart illustrating an operating method of an electronic device (e.g., wearable electronic device, smart watch, smart band) according to an embodiment of the disclosure;

FIG. 24 is a flowchart illustrating an operating method of an electronic device (e.g., wearable electronic device, smart watch, smart band) according to an embodiment of the disclosure; and

FIG. 25 is a flowchart illustrating an operating method of an electronic device (e.g., wearable electronic device, smart watch, smart band) according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

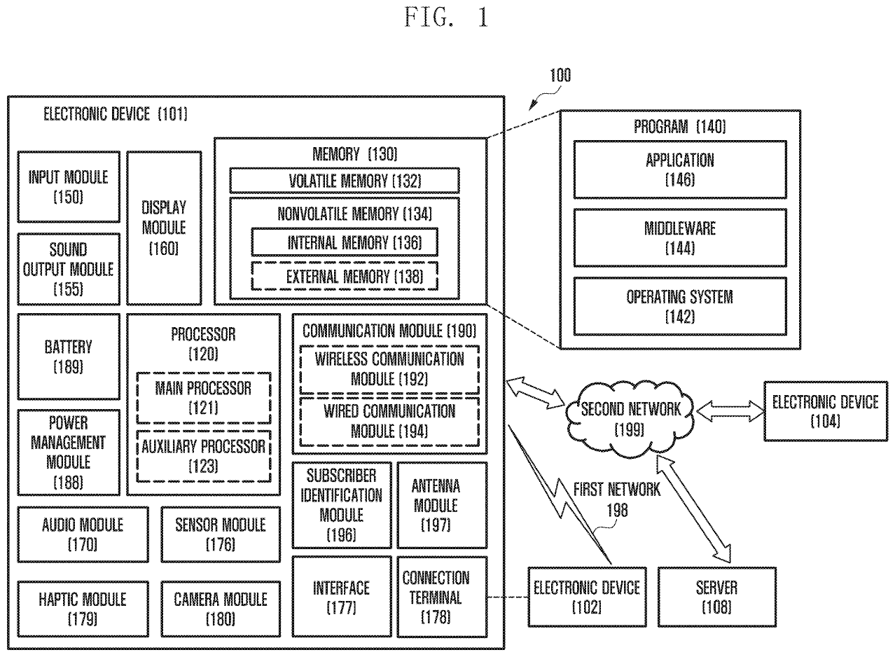

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to another embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to another embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to another embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to another embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

An electronic device according to various embodiments disclosed herein may be a device in various forms. The electronic device may include, for example, a portable communication device (e.g., smartphone), a computer device, a portable multimedia device, a portable medical device, a camera, a wearable device, or a home appliance device. The electronic device according to an embodiment herein is not limited to the above-described devices.

Various embodiments and terms used herein are not construed to limit technical features disclosed herein to specific embodiments, and should be understood to include various modifications, equivalents, or substitutions of a corresponding embodiment. Herein, each of the expressions, “A or B,” “at least one of A and B,” “at least one of A or B,” “A, B, or C,” “at least one of A, B, and C,” “at least one of A, B, or C,” and the like may include any possible combinations of items listed with a corresponding expression among the expressions. Terms “first,” “second,” etc., are simply used to distinguish one component from another component and do not limit the corresponding components in another aspect (e.g., importance or order). When a (e.g., first) component is described to be “coupled” or “connected to” another (e.g., second) component along with the term “functionally” or “communicatively,” the component may be directly (e.g., wiredly) connected to the other component or may be connected through a third component.

The term “module” used in various embodiments herein may include a unit implemented as hardware, software, or firmware, and may be interchangeably used with the terms, for example, logic, logic block, part, and circuit. The module may be an integrally configured part or a minimal unit of the part that performs one or more functions or a portion thereof. For example, according to an embodiment, the module may be implemented in a form of an application-specific integrated circuit (ASIC).

Various embodiments disclosed herein may be implemented as software (e.g., program 140) that includes one or more commands stored in a storage medium (e.g., internal memory 136 or external memory 138) readable by a machine (e.g., electronic device 101). A processor (e.g., processor 120) of the machine (e.g., electronic device 101) may call and execute at least one command among the one or more commands stored in the storage medium, which enables the device to operate to perform at least one function in response to the called at least one command. The one or more commands may include a code generated by a compiler or a code executable by an interpreter. The storage medium readable by the device may be provided in the form of a non-transitory storage medium. Here, “non-transitory” simples indicates that the storage medium is a tangible device and does not include a signal (e.g., electromagnetic wave). This term does not distinguish a case in which data is semi-permanently stored in the storage medium from a case in which the data is transitorily stored in the storage medium.

The method according to various embodiments disclosed herein may be included in a computer program product and thereby provided. The computer program product may be traded between a seller and a purchaser. The computer program product may be distributed in a form of a storage medium readable by machine (e.g., compact disc read only memory (CD-ROM)) or may be distributed (e.g., downloaded or uploaded) directly or online through an application store (e.g., PlayStore™) or between two user devices (e.g., smartphones). In the case of online distribution, at least a portion of the computer program product may be at least transitorily stored or temporarily generated in a server of a manufacturer, a server of application store, or a storage medium readable by machine such as memory of a repeater server.

According to various embodiments, each component (e.g., module or program) of the above-described components may include a single entity or multiple entities, and some of the multiple entities may be separately arranged in different components. According to other embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in different order or omitted, or one or more other operations may be added.

According to an embodiment, the processor 120 (e.g., processing circuit) may be implemented as at least one integrated circuit (IC) (or circuitry) chip. the processor 120 may include at least one electrical circuit, and may individually or collectively process instructions (or program, data) stored in the memory 130 in a distributed manner. The processor 120 may include a processor assembly that includes one or more processing circuits. The processor 120 may include, for example, operative any processing circuit to control performance and operations of one or more components (e.g., memory 130, display module 160, sensor module 176 (e.g., sensor), camera module 180 (e.g., image sensor), and/or communication module 190 (e.g., communication circuit)) of the electronic device 101. For example, the processor 120 (e.g., application processor (AP)) may be implemented as a system on chip (SoC) (e.g., single chip or chipset). For example, the processor 120 may be implemented as a plurality of cores (or at least one core circuit), a plurality of chips, or a plurality of chipsets. For example, the processor 120 may include one or more processing circuits. For example, the processor 120 may include one or more processing circuits configured to individually and/or collectively perform various functions of the disclosure. As a non-limiting example, at least a portion of the processor 120 may be included in a first chip of the electronic device 101, and at least another portion of the processor 120 may be included in a second chip of the electronic device 101 that is different from the first chip of the electronic device 101.

The electronic device 101 illustrated in FIG. 1 may include a wearable electronic device, a smart watch, an augmented reality (AR) electronic device, a virtual reality (VR) electronic device, a mobile phone (e.g., smart phone), a laptop personal computer (PC), a tablet PC, and/or an audio electronic device (e.g., wired earphone, wireless earphone).

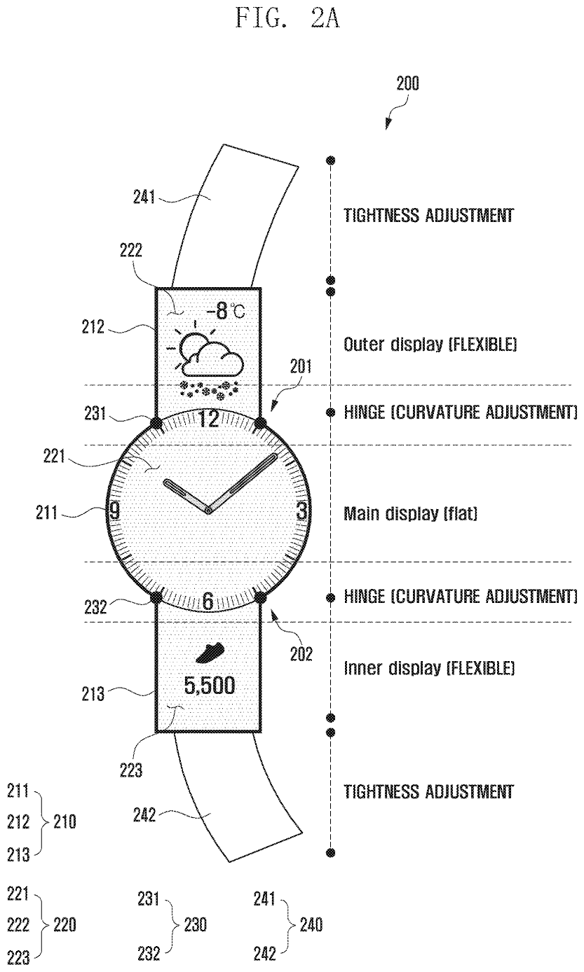

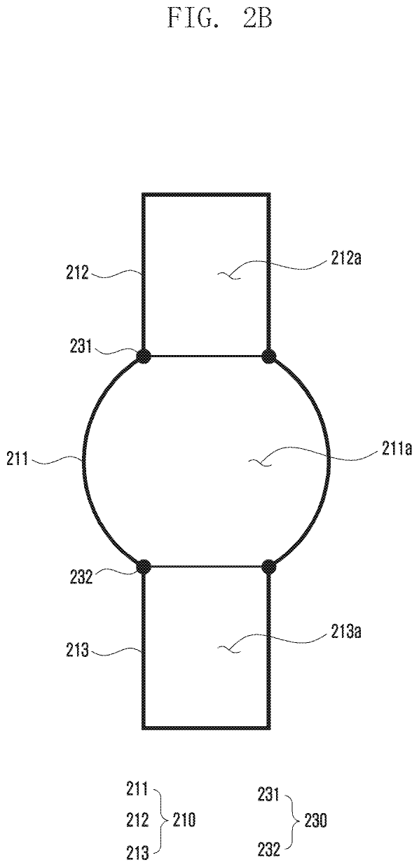

According to an embodiment, the display module 160 illustrated in FIG. 1 may include a display (e.g., display 220 of FIG. 2A). For example, the display 220 may include a first display (e.g., first display 221 of FIG. 2A, main display, center display, main display area), a second display (e.g., second display 222 FIG. 2A, first sub-display, first sub-display area, outer display), and a third display (e.g., third display 223 of FIG. 2A, second sub-display, second sub-display area, inner display).

For example, the first display 221 may include a bar typed or plate typed display (e.g., organic light emitting diode (OLED) display). For example, the first display 221 may include a flexible display (e.g., flexible OLED display) configured to fold or unfold a screen (e.g., display screen).

For example, the second display 222 may include a bar typed or plate typed display (e.g., OLED display). For example, the second display 222 may include a flexible display (e.g., flexible OLED display) configured to fold or unfold the screen (e.g., display screen).

For example, the third display 223 may include a bar typed or plate typed display (e.g., OLED display). For example, the third display 223 may include a flexible display (e.g., flexible OLED display) configured to fold or unfold the screen (e.g., display screen).

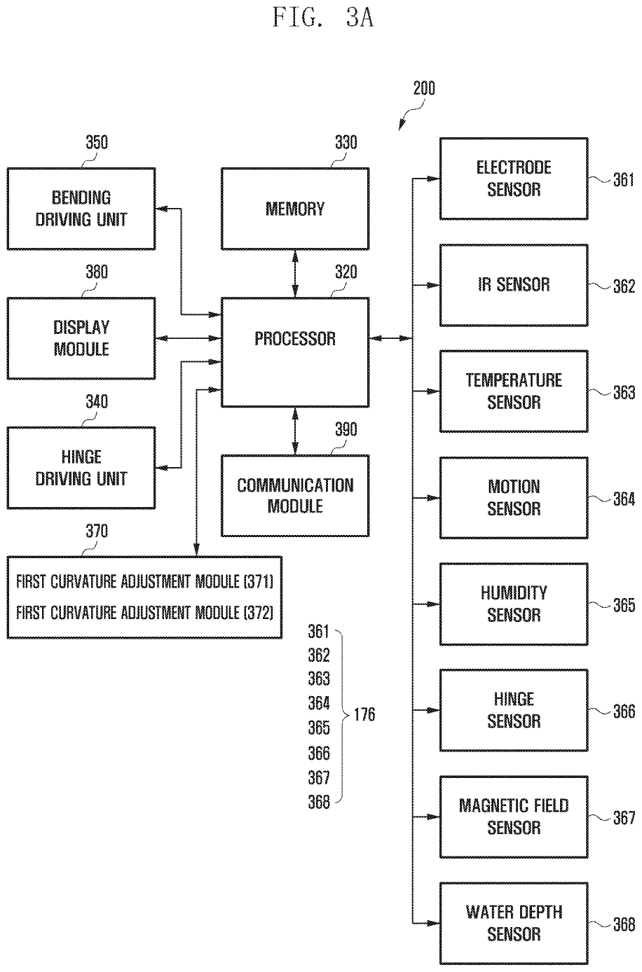

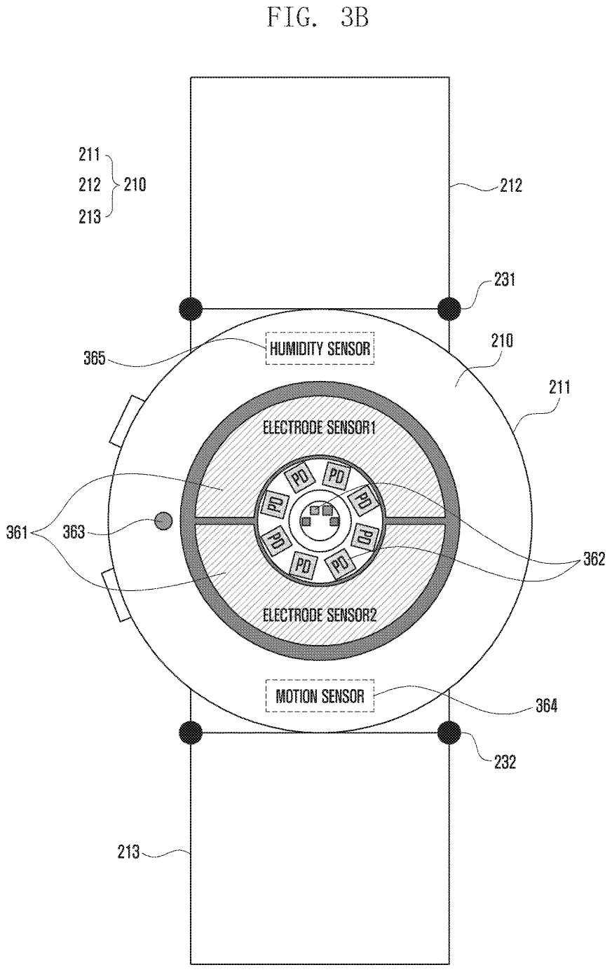

According to another embodiment, the sensor module 176 may include an electrical proximity sensor (e.g., electrode sensor 361 of FIG. 3A). For example, the sensor module 176 may include an optical proximity sensor (e.g., optical sensor) (e.g., photoplethysmogram sensor (PPG sensor) (e.g., IR sensor 362 FIG. 3A)). For example, the sensor module 176 may include a temperature sensor (e.g., temperature sensor 363 FIG. 3A) that may measure the user's skin temperature and body temperature, and external temperature. For example, the sensor module 176 may include a motion sensor (e.g., motion sensor 364 of FIG. 3A) that may measure movement of the electronic device 101 (e.g., electronic device 200 of FIG. 2A, wearable electronic device). The motion sensor 364 may include a 6-axis sensor and an acceleration sensor that may measure the movement of the electronic device 101, 200 (e.g., wearable electronic device) and the angle at which the electronic device 101, 200 is worn on the user's body (e.g., wrist).

According to an embodiment, the sensor module 176 may sense the angle between structures of a housing 210 and the curvature of the second display 222 (e.g., first sub-display, outer display).

For example, the motion sensor (6-axis sensor & acceleration sensor) may be used to measure the curvature of the second display 222 (e.g., first sub-display, outer display) and to acquire a curvature value. The electronic device 101, 200 (e.g., wearable electronic device) may change the curvature of the second display 222 (e.g., first sub-display, outer display) based on the curvature value of the second display 222 (e.g., first sub-display, outer display).

The sensor module 176 my sense the angle between the structures of the housing 210, and may sense the curvature of the third display 223 (e.g., second sub-display, inner display).

For example, the motion sensor (6-axis sensor & acceleration sensor) may be used to measure the curvature of the third display 223 (e.g., second sub-display, inner display) and may acquire a curvature value. The electronic device 101, 200 (e.g., wearable electronic device) may change the curvature of the third display 223 (e.g., second sub-display, inner display) based on the curvature value of the third display 223 (e.g., second sub-display, inner display). For example, the motion sensor 364 may include a location measurement sensor (e.g., global positioning system (GPS) sensor) that may measure a location of the electronic device 101, 200 (e.g., wearable electronic device). For example, the sensor module 176 may include a humidity sensor (e.g., humidity sensor 365 of FIG. 3A) that may measure the humidity of the user's skin and external humidity. For example, the sensor module 176 may include a hinge sensor (e.g., hinge sensor 366 of FIG. 3A) that may measure the movement angle of a first hinge (e.g., first hinge driving module 231 of FIGS. 2A and 2B) configured to connect the first housing (e.g., first housing 211 of FIGS. 2A and 2B) and the second housing (e.g., second housing 212. of FIGS. 2A and 2B) of the electronic device 101, 200 (e.g., wearable electronic device). For example, the sensor module 176 may include a hinge sensor (e.g., hinge sensor 366 of FIG. 3A) that may measure the movement angle of a second hinge driving module (e.g., second hinge driving module 232 of FIGS. 2A and 2B) configured to connect the first housing (e.g., first housing 211 of FIGS. 2A and 2B) and the third housing (e.g., third housing 213 FIGS. 2A and 2B) of the electronic device 101, 200 (e.g., wearable electronic device). For example, the sensor module 176 may include a magnetic field sensor (e.g., magnetic field sensor 367 of FIG. 3A, hall sensor) that may measure the angle between the first housing 211 and the second housing 212 (e.g., angle formed by folding and unfolding of first housing 211 and second housing 212). For example, the sensor module 176 may include a magnetic field sensor (e.g., magnetic field sensor 367 of FIG. 3A, hall sensor) that may measure the angle between the first housing 211 and the third housing 213 (e.g., angle formed by folding and unfolding of first housing 211 and third housing 213). For example, the sensor module 176 may include a water depth sensor (e.g., FIG. 3A water depth sensor 368) that may measure the depth of water when the electronic device 101, 200 (e.g., wearable electronic device) is present in water. For example, the sensor module 176 may include an altitude sensor that may measure the height of a location at which the electronic device 101, 200 (e.g., wearable electronic device) is present. For example, the sensor module 176 may include a barometric sensor that may measure the barometric pressure of a location at which the electronic device 101, 200 (e.g., wearable electronic device) is present.

FIG. 2A illustrates a wearable electronic device (e.g., smart watch, smart band) according to an embodiment of the disclosure.

FIG. 2B illustrates a housing and a hinge of an electronic device (e.g., wearable electronic device, smart watch, smart band) according to an embodiment of the disclosure.

Referring to FIGS. 2A and 2B, the electronic device 200 (e.g., wearable electronic device, smart watch, smart band) according to an embodiment of the disclosure may include a first surface (e.g., surface on which screen of display 220 is displayed), a second surface (e.g., rear surface, surface that comes into contact with skin of person), and a third surface (e.g., side surface) arranged to surround the space between the first surface (e.g., surface on which screen of display 220 is displayed) and the second surface (e.g., rear surface, surface that comes into contact with skin of person).

The electronic device 200 (e.g., electronic device 101 of FIG. 1, wearable electronic device, smart watch, smart band) according to an embodiment of the disclosure may include the housing 210, a display module (e.g., display module 160 of FIG. 1, display module 380 of FIG. 3A) including the display 220, a fastening member 240 configured to fasten the electronic device 200 to the wrist of the user, and driving circuits configured to operate the electronic device 200. The driving circuits of the electronic device 200 may reference detailed description of FIGS. 3A and 3B.

According to an embodiment, the electronic device 200 (e.g., wearable electronic device, smart watch, smart band) illustrated in FIG. 2A may include a wearable electronic device (e.g., smart watch).

According to an embodiment, the electronic device 200 (e.g., wearable electronic device, smart watch, smart band) illustrated in FIG. 2A may include an augmented reality (AR) electronic device, a virtual reality (VR) electronic device, a mobile phone (e.g., smartphone), a laptop personal computer (PC), a tablet PC, and/or an audio electronic device (e.g., wired earphone, wireless earphone).

According to an embodiment, the housing 210 may include the first housing 211 (e.g., main housing, center housing), the second housing 212 (e.g., first sub-housing, outer housing), and the third housing 213 (e.g., second sub-housing, inner housing).

For example, the first housing 211 (e.g., main housing) may be arranged between the second housing 212 (e.g., first sub-housing) and the third housing 213 (e.g., second sub-housing).

The first side 201 of the first housing 211 (e.g., main housing) may be connected to the second housing 212 (e.g., first sub-housing). The first housing 211 (e.g., main housing) and the second housing 212 (e.g., first sub-housing) may be connected by way of the first hinge driving module 231.

For example, the second side 202 of the first housing 211 (e.g., main housing) may be connected to the third housing 213 (e.g., second sub-housing). The first housing 211 (e.g., main housing) and the third housing 213 (e.g., second sub-housing) may be connected by way of the second hinge driving module 232.

According to an embodiment, a hinge 230 may include the first hinge driving module 231 and the second hinge driving module 232.

The first hinge driving module 231 may connect the first housing 211 (e.g., main housing) and the second housing 212 (e.g., first sub-housing). The angle formed by the first housing 211 (e.g., main housing) and the second housing 212 (e.g., first sub-housing) may be changed by way of the first hinge driving module 231. The first housing 211 (e.g., main housing) and the second housing 212 (e.g., first sub-housing) may be folded or unfolded by way of the first hinge driving module 231. For example, the first hinge driving module 231 may be driven by way of a hinge driving unit (e.g., hinge driving unit 340 of FIG. 3A).

For example, the second hinge driving module 232 may connect the first housing 211 (e.g., main housing) and the third housing 213 (e.g., second sub-housing). The angle formed by the first housing 211 (e.g., main housing) and the third housing 213 (e.g., second sub-housing) may be changed by way of the second hinge driving module 232. The first housing 211 (e.g., main housing) and the third housing 213 (e.g., second sub-housing) may be folded or unfolded by way of the second hinge driving module 232. For example, the second hinge driving module 232 may be driven by way of a hinge driving unit (e.g., hinge driving unit 340 of FIG. 3A).

According to an embodiment, the fastening member 240 may include a strap that wraps around and fastens the electronic device 200 (e.g., wearable electronic device, smart watch, smart band) to the wrist of the user.

The first side 241 of the strap-shaped fastening member 240 may be connected to the second housing 212 (e.g., first sub-housing). The second side 242 of the strap-shaped fastening member 240 may be connected to the third housing 213 (e.g., second sub-housing). For example, the first side 241 and the second side 242 of the fastening member 240 may be separable straps that are separated from each other but connectable by a connecting method.

According to an embodiment, the fastening member 240 may include a band (e.g., elastic band) that wraps around and fastens the electronic device 200 (e.g., wearable electronic device, smart watch, smart band) to the wrist of the user.

For example, the first side 241 of the elastic band-shaped fastening member 240 may be connected to the second housing 212 (e.g., first sub-housing). The second side 242 of the elastic band-typed fastening member 240 may be connected to the third housing 213 (e.g., second sub-housing). For example, the first side 241 and the second side 242 of the fastening member 240 may be a single elastic band that is connected to each other.

According to another embodiment, the display 220 may include the first display 221 (e.g., main display, center display), the second display 222 (e.g., first sub-display, outer display), and the third display 223 (e.g., second sub-display, inner display).

For example, the first display 221 (e.g., main display, center display) may be arranged in a first space 211a formed by the first housing 211 (e.g., main housing, center housing). For example, the first display 221 (e.g., main display, center display) may be supported by the first housing 211 (e.g., main housing, center housing).

For example, the second display 222 (e.g., first sub-display) may be arranged in a second space 212a formed by the second housing 212 (e.g., first sub-housing). For example, the second display 222 (e.g., first sub-display) may be supported by the second housing 212 (e.g., first sub-housing).

The third display 223 (e.g., second sub-display) may be arranged in a third space 213a formed by the third housing 213 (e.g., second sub-housing). For example, the third display 223 (e.g., second sub-display) may be supported by the third housing 213 (e.g., second sub-housing).

According to an embodiment, the first display 221 (e.g., main display, center display, main display area), the second display 222 (e.g., first sub-display, first sub-display area), and the third display 223 (e.g., second sub-display, second sub-display area) may be manufactured as a single flexible display and arranged in the housing 210. By dividing an area of a single flexible display, each of the first display 221 (e.g., main display, center display, main display area), the second display 222 (e.g., first sub-display, first sub-display area), and the third display 223 (e.g., second sub-display, second sub-display area) may operate as an independent display.

For example, each of the first display 221 (e.g., main display, center display, main display area), the second display 222 (e.g., first sub-display, first sub-display area), and the third display 223 (e.g., second sub-display, second sub-display area) may operate as an independent display, and may display different content.

The first display 221 (e.g., main display, center display, main display area), the second display 222 (e.g., first sub-display, first sub-display area), and the third display 223 (e.g., second sub-display, second sub-display area) may split and display a single piece of content by operating in conjunction with each other.

According to an embodiment, the first display 221 (e.g., main display, center display, main display area), the second display 222 (e.g., first sub-display, first sub-display area), and the third display 223 (e.g., second sub-display, second sub-display area) may be manufactured as displays that are separated from each other, and may be arranged in the housing 210.

For example, when viewed from the outside, the first display 221 (e.g., main display, center display, main display area), the second display 222 (e.g., first sub-display, first sub-display area), and the third display 223 (e.g., second sub-display, second sub-display area) may be viewed as a single connected display.

For example, when viewed from the outside, the first display 221 (e.g., main display, center display, main display area), the second display 222 (e.g., first sub-display, first sub-display area), and the third display 223 (e.g., second sub-display, second sub-display area) may be viewed as displays that are separated from each other.

For example, each of the first display 221 (e.g., main display, center display, main display area), the second display 222 (e.g., first sub-display, first sub-display area), and the third display 223 (e.g., second sub-display, second sub-display area) may operate as an independent display.

For example, each of the first display 221 (e.g., main display, center display, main display area), the second display 222 (e.g., first sub-display, first sub-display area), and the third display 223 (e.g., second sub-display, second sub-display area) may operate as an independent display and may display different content.

The first display 221 (e.g., main display, center display, main display area), the second display 222 (e.g., first sub-display, first sub-display area), and the third display 223 (e.g., second sub-display, second sub-display area) may split and display a single piece of content by operating in conjunction with each other.

For example, the first display 221 (e.g., main display, center display, main display area) may include a bar typed or plate typed display (e.g., organic light emitting diode (OLED) display). For example, the first display 221 (e.g., main display, center display, main display area) may include a flexible display (e.g., flexible OLED display) configured to fold or unfold the screen (e.g., display screen).

The second display 222 (e.g., first sub-display, first sub-display area) may include a bar typed or plate typed display (e.g., OLED display). For example, the second display 222 (e.g., first sub-display, first sub-display area) may include a flexible display (e.g., flexible OLED display) configured to fold or unfold the screen (e.g., display screen).

For example, the third display 223 (e.g., second sub-display, second sub-display area) may include a bar typed or plate typed display (e.g., OLED display). For example, the third display 223 (e.g., second sub-display, second sub-display area) may include a flexible display (e.g., flexible OLED display) configured to fold or unfold the screen (e.g., display screen).

According to an embodiment, the electronic device 200 (e.g., wearable electronic device, smart watch, smart band) may adjust the bending curvature of the first display 221 (e.g., main display, center display, main display area), the second display 222 (e.g., first sub-display, first sub-display area), and the third display 223 (e.g., second sub-display, second sub-display area).

In an example, the electronic device 200 (e.g., wearable electronic device, smart watch, smart band) may adjust the bending curvature of the first display 221 (e.g., main display, center display, main display area) such that the first display 221 (e.g., main display, center display, main display area) has a flat shape. For example, the electronic device 200 (e.g., wearable electronic device, smart watch, smart band) may adjust the bending curvature of the first display 221 (e.g., main display, center display, main display area) such that the first display 221 (e.g., main display, center display, main display area) has a curved shape (e.g., shape curved to fit shape of wrist). For example, the bending curvature of the first display 221 (e.g., main display, center display, main display area) may be controlled by a bending driving unit (e.g., bending driving unit 350 of FIG. 3A).

For example, the electronic device 200 (e.g., wearable electronic device, smart watch, smart band) may adjust the bending curvature of the second display 222 (e.g., first sub-display, first sub-display area) such that the second display 222 (e.g., first sub-display, first sub-display area) has a flat shape. For example, the electronic device 200 (e.g., wearable electronic device, smart watch, smart band) may adjust the bending curvature of the second display 222 (e.g., first sub-display, first sub-display area) such that the second display 222 (e.g., first sub-display, first sub-display area) has a curved shape (e.g., shape curved to fit shape of wrist). For example, the bending curvature of the second display 222 (e.g., first sub-display, first sub-display area) may be controlled by the bending driving unit (e.g., bending driving unit 350 of FIG. 3A).

The electronic device 200 (e.g., wearable electronic device, smart watch, smart band) may adjust the bending curvature of the third display 223 (e.g., second sub-display, second sub-display area) such that the third display 223 (e.g., second sub-display, second sub-display area) has a flat shape. For example, the electronic device 200 (e.g., wearable electronic device, smart watch, smart band) may adjust the bending curvature of the third display 223 (e.g., second sub-display, second sub-display area) such that the third display 223 (e.g., second sub-display, second sub-display area) has a curved shape (e.g., shape curved to fit shape of wrist). For example, the bending curvature of the third display 223 (e.g., second sub-display, second sub-display area) may be controlled by the bending driving unit (e.g., bending driving unit 350 of FIG. 3A).

In this way, by adjusting the bending curvature of at least a portion of the display 220, when the electronic device 200 (e.g., wearable electronic device, smart watch, smart band) is worn on the wrist of the user, the electronic device 200 may be adjusted to be worn loosely or to be worn tightly.

According to an embodiment, the electronic device 200 (e.g., wearable electronic device, smart watch, smart band) may drive the first hinge driving module 231 to adjust the angle formed by the first housing 211 (e.g., main housing) and the second housing 212 (e.g., first sub-housing). The electronic device 200 (e.g., wearable electronic device, smart watch, smart band) may drive the second hinge driving module 232 to adjust the angle formed by the first housing 211 (e.g., main housing) and the third housing 213 (e.g., second sub-housing).

In this way, when the electronic device 200 (e.g., wearable electronic device, smart watch, smart band) is worn on the wrist of the user, the hinge 230 may be driven to adjust the angle of the housing 210 and the electronic device 200 may be controlled to be worn loosely or to be worn tightly.

According to another embodiment, the electronic device 200 (e.g., wearable electronic device, smart watch, smart band) may drive the hinge 230 to adjust the angle of the housing 210 and to adjust the bending curvature of at least a portion of the display 220, and the electronic device 200 may be controlled to be worn loosely or to be worn tightly.

FIG. 3A is a block diagram of an electronic device (e.g., wearable electronic device, smart watch, smart band) according to an embodiment of the disclosure.

FIG. 3B is a view observed from a rear surface (e.g., surface that comes into contact with wrist) of an electronic device (e.g., wearable electronic device, smart watch, smart band) according to an embodiment of the disclosure.

Referring to FIGS. 3A and 3B, according to an embodiment, the electronic device 200 (e.g., wearable electronic device, smart watch, smart band) according to an embodiment of the disclosure may include driving circuits.

According to an embodiment, driving circuits of the electronic device 200 (e.g., wearable electronic device, smart watch, smart band) may include a processor 320 (e.g., processor 120 of FIG. 1), memory 330 (e.g., memory 130 of FIG. 1), the hinge driving unit 340, the bending driving unit 350, the sensor module 176 (e.g., sensor module 176 of FIG. 1, sensor circuit), a curvature adjustment module 370, the display module 380 (e.g., display module 160 of FIG. 1), and a communication module 390 (e.g., communication module 190 of FIG. 1).

According to an embodiment, the processor 320, the memory 330, the sensor module 176, the hinge driving unit 340, the bending driving unit 350, the display module 380, and the communication module 390 may be arranged in an internal space formed by the housing 210 of the electronic device 200 (e.g., wearable electronic device, smart watch, smart band).

According to an embodiment, the electronic device 200 (e.g., wearable electronic device, smart watch, smart band) according to an embodiment of the disclosure may include a battery (e.g., battery 189 of FIG. 1) configured to supply power for operation of the electronic device 200. For example, the battery 189 may include a non-rechargeable primary cell, a rechargeable secondary cell, or a fuel cell. The battery 189 may be integrally provided inside the electronic device 200, or may be detachably provided to the electronic device 200.

According to an embodiment, the sensor module 176 may include an electrical proximity sensor (e.g., electrode sensor 361 of FIG. 3A).

For example, the sensor module 176 may include an optical proximity sensor (e.g., optical sensor) (e.g., photoplethysmogram sensor (PPG sensor)) (e.g., IR sensor 362 of FIG. 3A).

For example, the sensor module 176 may include a temperature sensor (e.g., temperature sensor 363 of FIG. 3A) that may measure the user's skin temperature and body temperature, and external temperature.

For example, the sensor module 176 may include a motion sensor (e.g., motion sensor 364 of FIG. 3A) that may measure the movement of the electronic device 101 (e.g., electronic device 200 of FIG. 2A, wearable electronic device, smart watch, smart band). The motion sensor 364 may include a 6-axis sensor and an acceleration sensor that may measure movement of the electronic device 101, 200 and the angle at which the electronic device 101, 200 is worn on the user's body (e.g., wrist). The motion sensor 364 may include a location measurement sensor (e.g., global positioning system (GPS) sensor) that may measure a location of the electronic device 101, 200.

The sensor module 176 may include the humidity sensor 365 that may measure the humidity of the user's skin and external humidity.

For example, the sensor module 176 may include the hinge sensor 366 that may measure the movement angle of the first hinge driving module (e.g., first hinge driving module 231 of FIGS. 2A and 2B) connecting the first housing (e.g., first housing 211 of FIGS. 2A and 2B) and the second housing (e.g., second housing 212 of FIGS. 2A and 2B) of the electronic device 101, 200 (e.g., wearable electronic device, smart watch, smart band). For example, the hinge sensor 366 may be embedded in a first hinge driving module (e.g., first hinge driving module 231 of FIGS. 2A and 2B) and may measure the movement angle of the first hinge driving module 231. For example, the sensor module 176 may include the hinge sensor 366 that may measure the movement angle of the second hinge (e.g., second hinge driving module 232 of FIGS. 2A and 2B) connecting the first housing (e.g., first housing 211 of FIGS. 2A and 2B) and the third housing (e.g., third housing 213 of FIGS. 2A and 2B) of the electronic device 101, 200.

For example, the hinge sensor 366 may be embedded in the second hinge driving module (e.g., second hinge driving module 232 of FIGS. 2A and 2B) and may measure the movement angle of the second hinge driving module 232.

For example, the sensor module 176 may include the magnetic field sensor 367 (e.g., hall sensor) that may measure the angle between the first housing 211 and the second housing 212 (e.g., angle formed by folding and unfolding of first housing 211 and second housing 212).

The sensor module 176 may include the magnetic field sensor 367 (e.g., hall sensor) that may measure the angle between the first housing 211 and the third housing 213 (e.g., angle formed by folding and unfolding of first housing 211 and third housing 213).

For example, when the electronic device 101, 200 (e.g., wearable electronic device, smart watch, smart band) is present in water, the sensor module 176 may include the water depth sensor 368 that may measure the depth of water.

For example, the sensor module 176 may include the altitude sensor that may measure the height of a location at which the electronic device 101, 200 (e.g., wearable electronic device, smart watch, smart band) is present. For example, the sensor module 176 may include the barometric sensor that may measure the barometric pressure of a location at which the electronic device 101, 200 is present.

In an example, at least a portion of the sensor module 176 may be arranged to face the first surface (e.g., front surface, surface on which screen is displayed) of the electronic device 101, 200 (e.g., wearable electronic device, smart watch, smart band). For example, at least a portion of the sensor module 176 may be arranged to face the second surface (e.g., rear surface, surface that comes into skin of user) of the electronic device 101, 200. For example, at least a portion of the sensor module 176 may be arranged in the first housing 211. For example, at least a portion of the sensor module 176 may be arranged in the second housing 212. For example, at least a portion of the sensor module 176 may be arranged in the third housing 213. For example, at least a portion of the sensor module 176 may be arranged in the first display 221. For example, at least a portion of the sensor module 176 may be arranged in the second display 222. For example, at least a portion of the sensor module 176 may be arranged in the third display 223.

According to an embodiment, the electrode sensor 361 (e.g., electrical proximity sensor), the IR sensor 362 (e.g., optical proximity sensor), and the temperature sensor 363 (e.g., contact-free temperature sensor) may be provided to face the second surface (e.g., rear surface, surface that comes into contact with human skin) of the electronic device 200 (e.g., wearable electronic device, smart watch, smart band).

For example, the electrode sensor 361 (e.g., electrical proximity sensor), the IR sensor 362 (e.g., optical proximity sensor), and the temperature sensor 363 (e.g., contact-free temperature sensor) may be provided to be adjacent to a rear plate of the wearable electronic device 200.

According to another embodiment, the motion sensor 364 may be arranged in an internal space of the electronic device 200 (e.g., wearable electronic device, smart watch, smart watch), and may not be visible from the outside.

According to an embodiment, a display (e.g., display 220 of FIG. 2A) of the display module 380 may be provided to face the second surface (e.g., surface on which screen is displayed) of the electronic device 200 (e.g., wearable electronic device, smart watch, smart band). For example, the display 220 may be exposed to be visually visible. A shape of the display 220 may be formed to correspond to a frontal shape of the housing 210.

For example, the first display 221 (e.g., main display, center display, main display area) may be in the shape of a circle, an ellipse, or a polygon.

The second display 222 (e.g., first sub-display, first sub-display area) may be in the shape of a circle, an ellipse, or a polygon.

For example, third display 223 (e.g., second sub-display, second sub-display area) may be in the shape of a circle, an ellipse, or a polygon.

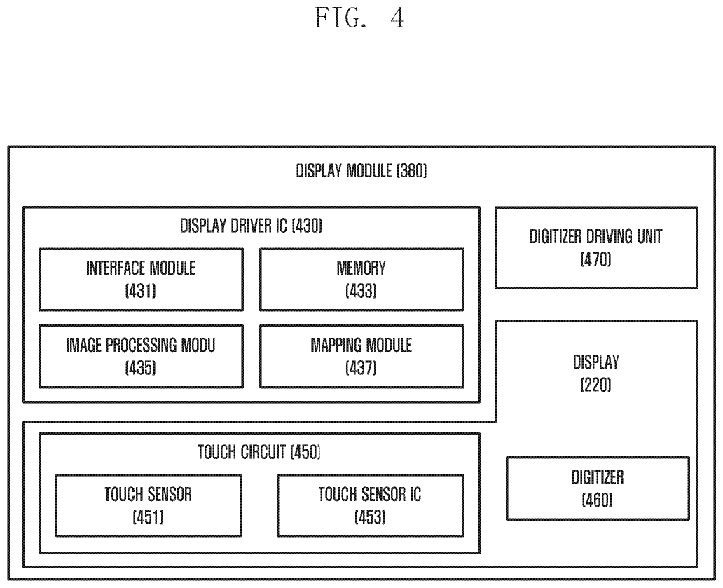

According to an embodiment, the display module 380 may include a touch circuit (touch circuit 450 of FIG. 4). Presence or absence of touch and intensity (pressure) of touch may be measured through the touch circuit 450. A touch sensor (e.g., touch sensor 451 of FIG. 4) of the touch circuit 450 may be combined with or provided to be adjacent to a pressure sensor and/or a fingerprint sensor.

According to an embodiment, the processor 320 of the electronic device 200 (e.g., wearable electronic device, smart watch, smart band) according to an embodiment of the disclosure may include one or more of a central processing unit, an application processor, a graphics processing unit (GPU), an application processor, a sensor processor, and a communication processor. For example, the processor 320 may control the operation of the communication module 390 to operate in conjunction with an external electronic device and/or an external wearable electronic device.

According to another embodiment, the processor 320 (e.g., processing circuit) may be implemented as at least one integrated circuit (or circuitry) (IC) chip, and may execute various data processing. The processor 320 may include at least one electrical circuit, and may individually or collectively distribute and process instructions (or program, data) stored in the memory 330. For example, the processor 320 may include at least some components of the processor 120 of FIG. 1, and may perform at least some operations of the processor 120 of FIG. 1.

According to an embodiment, the memory 330 of the electronic device 200 (e.g., wearable electronic device, smart watch, smart band) according to an embodiment of the disclosure may include a volatile memory and/or nonvolatile memory. For example, the memory 330 may include instructions for performing the operation of the processor 320. Also, the memory 330 may include instructions for performing the operation of the electrode sensor 361, the IR sensor 362, the temperature sensor 363, the motion sensor 364, the humidity sensor 365, the hinge sensor 366, the magnetic field sensor 367, the water depth sensor 368, the display module 380, and/or the communication module 390.

The electronic device 200 (e.g., wearable electronic device, smart watch, smart band) according to an embodiment of the disclosure may be worn on the user's body (e.g., wrist). The electronic device 200 (e.g., wearable electronic device, smart watch, smart band) may operate in conjunction with the external electronic device (e.g., smart phone, tablet PC, laptop PC) and/or the external wearable electronic device (e.g., audio electronic device, wireless earphones).

According to an embodiment, the processor 320 of the electronic device 200 (e.g., wearable electronic device, smart watch, smart band) according to an embodiment of the disclosure may control the operation of at least one of the electrode sensor 361, the IR sensor 362, the temperature sensor 363, the motion sensor 364, the humidity sensor 365, the hinge sensor 366, the magnetic field sensor 367, and water depth sensor 368 to acquire the user's movement signal, an angle at which the electronic device 200 is worn on the user's wrist, an exercise signal, a health-related signal, a biometric signal (e.g., hearth rate, blood pressure, oxygen saturation, blood sugar, skin temperature, and/or body temperature), a humidity signal, a water depth signal, and an altitude signal.

The processor 320 of the electronic device 200 (e.g., wearable electronic device, smart watch, smart band) according to an embodiment of the disclosure may adjust the electronic device 200 (e.g., wearable electronic device, smart watch, smart band) to be worn loosely or tightly (e.g., adjust fit of wearable electronic device) based on at least one of a movement signal, a signal of angle at which the electronic device 200 is worn on the user's wrist, an exercise signal, a health-related signal, a biometric signal (e.g., heart rate, blood pressure, oxygen saturation, blood sugar, skin temperature, and/or body temperature), a humidity signal, a water depth signal, and an altitude signal that are acquired by operating the electrode sensor 361, the IR sensor 362, the temperature sensor 363, the motion sensor 364, the humidity sensor 365, the hinge sensor 366, the magnetic field sensor 367, and the water depth sensor 368.

According to an embodiment, the electrode sensor 361 may include at least one of an electrocardiogramsor, an electrical wear sensor, and an electrical proximity sensor. The electrode sensor 361 may acquire a biometric signal of the user based on the electrical signal in a circuit that detects a biometric signal. The biometric signal acquired from the electrode sensor 361 may be provided to the processor 320. For example, the processor 320 may determine whether the electronic device 200 (e.g., wearable electronic device, smart watch, smart watch) is worn based on the biometric signal from the electrode sensor 361.

According to another embodiment, the IR sensor 362 may include at least one of an optical proximity sensor, an optical sensor, and a PPG sensor. For example, the IR sensor 362 may include a light emitting portion configured with a plurality of LEDs that emit light and a light receiving portion configured with a plurality of photodiodes (PDs) that receive light and convert the same to an electrical signal. For example, the processor 320 may acquire a biometric signal of the user by operating the IR sensor 362. The processor 320 may determine whether the electronic device 200 (e.g., wearable electronic device, smart watch, smart band) is worn based on the biometric signal from the IR sensor 362.

According to an embodiment, the temperature sensor 363 may include at least one of a contact-typed temperature sensor and a contact-free temperature sensor. The temperature sensor 363 may measure the user's skin temperature or body temperature by reflecting characteristics of electromagnetic waves irradiated from an object according to its temperature. For example, the temperature sensor 363 (e.g., contact-free temperature sensor) may include a contact-free IR temperature sensor. For example, since the temperature inside the sensor may have influence due to characteristics of the contact-free temperature sensor, the temperature sensor 363 (e.g., contact-free temperature sensor) may include a temperature sensor configured to measure the internal temperature of the electronic device 200. The temperature sensor that measures the internal temperature of the electronic device 200 (e.g., wearable electronic device, smart watch, smart band) may include a thermistor. The internal temperature of the electronic device 200 may be measured using the thermistor. The temperature sensor may measure the internal temperature of the electronic device 200 and may generate a device temperature signal. The device temperature signal generated by the temperature sensor may be provided to the processor 320.

For example, the temperature sensor 363 may acquire a biometric signal according to the user's skin temperature or body temperature. The biometric signal may include data of the user's skin temperature or body temperature. For example, the biometric signal acquired from the temperature sensor 363 (e.g., contact-free temperature sensor) may be provided to the processor 320. For example, the processor 320 may determine whether the electronic device 200 (e.g., wearable electronic device, smart watch, smart band) is worn based on the third biometric signal from the temperature sensor 363.

The motion sensor 364 may detect a state (or posture, direction) of the electronic device 200 (e.g., wearable electronic device, smart watch, smart band), and an angle, movement, and inertia at which the state (or posture, direction) of the electronic device 200 (e.g., wearable electronic device, smart watch, smart band) is worn on the wrist of the user.

The motion sensor 364 may detect the angle, velocity, acceleration, angular velocity, and/or angular acceleration by the movement of the electronic device 200 (e.g., wearable electronic device, smart watch, smart band). The motion sensor 364 may generate a motion detection signal for the movement of the electronic device 200 (e.g., wearable electronic device, smart watch) and may provide the motion detection signal to the processor 320. For example, the processor 320 may determine the state (or posture, direction) of the electronic device 200 (e.g., wearable electronic device, smart watch, smart band), and the angle, movement, and inertia at which the state (or posture, direction) of the electronic device 200 (e.g., wearable electronic device, smart watch, smart band) is worn on the wrist of the user based on the motion detection signal from the motion sensor 364.

For example, the electronic device 200 (e.g., wearable electronic device, smart watch, smart band) may include a 6-axis sensor (e.g., acceleration sensor and gyro sensor). The 6-axis sensor may sense whether the user is in motion and the magnitude of the motion. A motion sensing value of the 6-axis sensor may be provided to the processor 320. The processor 320 may determine whether there was the motion of the user and the magnitude of the motion based on the motion sensing value from the 6-axis sensor. For example, the electronic device 200 (e.g., wearable electronic device, smart watch, smart band) may include a global positioning system (GPS) sensor to detect a current location.

According to an embodiment, the humidity sensor 365 may measure the humidity of the user's skin and the external humidity. The humidity sensor 365 may provide a humidity signal humidity signal (e.g., humidity data, humidity information) according to the result to the processor 320.

According to another embodiment, the hinge sensor 366 may measure the movement angle of the first hinge driving module 231 that connects the first housing 211 and the second housing 212. The hinge sensor 366 may provide a first hinge angle signal (e.g., first hinge angle data, first hinge angle information) according to the result of measuring the movement angle of the first hinge driving module 231 to the processor 320. For example, the hinge sensor 366 may be included in a sensor module (e.g., sensor module 176 of FIG. 3A, sensor circuit). For example, the hinge sensor 366 may be embedded in the first hinge driving module 231, and may measure the movement angle of the first hinge driving module 231.

According to an embodiment, the hinge sensor 366 may measure the movement angle of the second hinge driving module 232 that connects the first housing 211 and the third housing 213. The hinge sensor 366 may provide a second hinge angle signal (e.g., second hinge angle data, second hinge angle information) according to the result of measuring the movement angle of the second hinge driving module 232 to the processor 320. For example, the hinge sensor 366 may be included in the sensor module (e.g., sensor module 176 of FIG. 3A, sensor circuit). For example, the hinge sensor 366 may be embedded in the second hinge driving module 232, and may measure the movement angle of the second hinge driving module 232.

the magnetic field sensor 367 (e.g., hall sensor) may measure the angle between the first housing 211 and the second housing 212 (e.g., angle formed by folding and unfolding of first housing 211 and second housing 212). The magnetic field sensor 367 (e.g., hall sensor) may provide a first housing angle signal (e.g., first housing angle data, first housing angle information) according to the result of measuring the angle between the first housing 211 and the second housing 212 (e.g., angle formed by folding and unfolding of first housing 211 and second housing 212) to the processor 320.

According to an embodiment, the magnetic field sensor 367 (e.g., hall sensor) may measure the angle between the first housing 211 and the third housing 213 (e.g., angle formed by folding and unfolding of first housing 211 and second housing 213). The magnetic field sensor 367 (e.g., hall sensor) may provide a second housing angle signal (e.g., second housing angle data, second housing angle information) according to the result of measuring the angle between the first housing 211 and the third housing 213 (e.g., angle formed by folding and unfolding of first housing 211 and second housing 213) to the processor 320.

According to an embodiment, the water depth sensor 368 may measure the depth of water when the electronic device 200 (e.g., wearable electronic device, smart watch, smart band) is present in water. The water depth sensor 368 may provide a water depth signal (e.g., water depth data, water depth information) according to the result of measuring the depth of water to the processor 320.

The altitude sensor may measure the height of a location at which the electronic device 200 (e.g., wearable electronic device, smart watch, smart band) is present. The altitude sensor may provide an altitude signal (e.g., altitude data, altitude information) according to the result of measuring the height of a location at which the electronic device 200 (e.g., wearable electronic device, smart watch) is present to the processor 320.

According to an embodiment, the barometric sensor may measure the barometric pressure of a location at which the electronic device 200 (e.g., wearable electronic device, smart watch, smart band) is present. The barometric sensor may provide a barometric pressure signal (e.g., barometric pressure data, barometric pressure information) according to the result of measuring the barometric pressure of a location at which the electronic device 200 (e.g., wearable electronic device, smart watch) is present to the processor 320.

According to another embodiment, the curvature adjustment module 370 may include a first curvature adjustment module 371 and a second curvature adjustment module 372. For example, the second housing structure (e.g., second housing 212) may include the first curvature adjustment module 371. For example, the third housing structure (e.g., third housing 213) may include the second curvature adjustment module 372. For example, the first curvature adjustment module 371 may adjust the curvature of the second display (e.g., second display 222 of FIG. 2A, first sub-display, first sub-display area, outer display). For example, the second curvature adjustment module 372 may adjust the curvature of the third display (e.g., third display 223 of FIG. 2A, second sub-display, second sub-display area, inner display).

According to an embodiment, the electronic device 200 (e.g., wearable electronic device, smart watch, smart band) may adjust the bending curvature of at least a portion of the second display 222 and at least a portion of the third display 223 using the first curvature adjustment module 371 and second curvature adjustment module 372 based on the change in the activity state of the user.

According to an embodiment, the first curvature adjustment module 371 may include an actuator (e.g., electroactive polymer (EAP) strip) configured to change the curvature of the second display (e.g., second display 222 of FIG. 2A, first sub-display, first sub-display area, outer display).

According to an embodiment, the second curvature adjustment module 372 may include an actuator (e.g., electroactive polymer (EAP) strip) configured to change the curvature of the third display (e.g., third display 223 of FIG. 2A, second sub-display, second sub-display area, inner display). For example, the actuator (e.g., electroactive polymer (EAP) strip) may be attached on the back surface (e.g., rear surface) of the second display 222 and the third display 223. The size and/or shape of the actuator (e.g., electroactive polymer (EAP) strip) may change when stimulated by the electric field. The curvature of the back surface (e.g., rear surface) of the second display 222 and the third display 223 may be changed through the actuator (e.g., electroactive polymer (EAP) strip), and various curve profiles may be provided.

FIG. 4 is a block diagram of the display module illustrated in FIG. 3A according to an embodiment of the disclosure.

Referring to FIG. 4, the display module 380 (e.g., display module 160 of FIG. 1) of the electronic device 200 (e.g., wearable electronic device, smart watch, smart band) according to an embodiment of the disclosure may include the display 220, a display driver IC (DDIC) 430 (e.g., display driving unit) to drive the display 220, a touch circuit 450 to detect touch on the display 220, a digitizer 460 to detect the input of an electronic pen (e.g., stylus pen), and a digitizer driving unit 470 to drive the digitizer 460. Hereinafter, the display driver IC 430 may be referred to as ‘DDIC 430.’

According to an embodiment, the display 220 may include a first display (e.g., first display 221 of FIG. 2A, main display, center display, main display area), a second display (e.g., second display 222 of FIG. 2A, first sub-display, first sub-display area, outer display), and a third display (e.g., third display 223 of FIG. 2A, second sub-display, second sub-display area, inner display).

The DDIC 430 may separate and drive each of the first display 221 (e.g., main display, center display, main display area), the second display 222 (e.g., first sub-display, first sub-display area), and the third display 223 (e.g., second sub-display, second sub-display area). For example, the DDIC 430 may control each of the first display 221 (e.g., main display, center display, main display area), the second display 222 (e.g., first sub-display, first sub-display area), and the third display 223 (e.g., second sub-display, second sub-display area) to display content as a separate display.

According to an embodiment, the DDIC 430 may drive the first display 221 (e.g., main display, center display, main display area), the second display 222 (e.g., first sub-display, first sub-display area), and the third display 223 (e.g., second sub-display, second sub-display area) in conjunction with each other. For example, the DDIC 430 may control the first display 221 (e.g., main display, center display, main display area), the second display 222 (e.g., first sub-display, first sub-display area), and the third display 223 (e.g., second sub-display, second sub-display area) to display content as a single integrated display.

According to an embodiment, the DDIC 430 may operate based on control of a processor (e.g., processor 320 of FIG. 3A). For example, the DDIC 430 may include an interface module 431, memory 433 (e.g., buffer memory), an image processing module 435, or a mapping module 437.

According to an embodiment, the DDIC 430 may receive video data, or video information that contains a video control signal corresponding to an instruction for controlling the video data from another component of the electronic device (e.g., electronic device 101 of FIG. 1, electronic device 200 of FIG. 3) through the interface module 431.

According to another embodiment, the video information may be received from the processor 320 (e.g., main processor 121 of FIG. 1) (e.g., application processor) or an auxiliary processor (e.g., auxiliary processor 123 of FIG. 1) (e.g., graphics processing unit) that operates independently of functions of the main processor 121.

According to an embodiment, the DDIC 430 may communicate with the touch circuit 450 and/or sensor module 176 using the interface module 431. Also, the DDIC 430 may store at least a portion of the received video information in the memory 433. For example, the DDIC 430 may store at least a portion of the received video information in the memory 433 on a frame basis.

According to an embodiment, the image processing module 435 may perform preprocessing or postprocessing (e.g., resolution, brightness, or resizing) on at least a portion of the video data based on at least a characteristic of the video data or a characteristic of the display 220.

The mapping module 437 may generate a voltage value or a current value corresponding to the video data that is preprocessed or postprocessed through the image processing module 435. According to an embodiment, generation of the voltage value or the current value may be performed at least in portion based on, for example, the property of pixels of the display 220 (e.g., arrangement of pixels (RGB stripe or pentile structure), or size of each of subpixels).

According to an embodiment, at least some pixels of the display 220 may be driven based at least in portion on, for example, the voltage value or the current value, so visual information (e.g., text, image, or icon) corresponding to the video data may be displayed through the display 220.

According to an embodiment, the touch circuit 450 may include a touch sensor 451 (e.g., touch screen) and a touch sensor IC 453 (touch fingerprint sensor integrated circuit).

According to an embodiment, the touch circuit 450 may detect touch input or hovering input for a specific location of the display 220. The touch sensor IC 453 may control the touch sensor 451 (e.g., touch screen) to detect the touch input or the hovering input. For example, the touch sensor IC 453 may detect the touch input or the hovering input by measuring the change in a signal (e.g., voltage, light quantity, resistance, or charge amount) for the specific location of the display 220. The touch sensor IC 453 may provide information on the detected touch input or hovering input (e.g., location, area, pressure, or time) to the processor 320 (e.g., transmission to processor 320, input to processor 320).

The touch sensor 451 (e.g., touch screen) may be applied in an add-on manner in which the touch sensor 451 is separately manufactured and separately arranged in an upper portion (e.g., top portion) of the display 220.

According to an embodiment, the touch sensor 451 (e.g., touch screen) may be applied in an on-cell manner in which the touch sensor 451 is arranged in an upper portion of the display 220.

According to an embodiment, the touch sensor 451 (e.g., touch screen) may be applied in an in-cell manner in which the touch sensor 451 is arranged along with pixels of the display 220.

According to another embodiment, at least a portion (e.g., touch sensor IC 453) of the touch circuit 450 may be included as a portion of the DDIC 430 or the display 220.

According to an embodiment, at least a portion (e.g., touch sensor IC 453) of the touch circuit 450 may be included as a portion (e.g., auxiliary processor 123) of another component arranged outside the display module 380.

According to an embodiment, the display module 380 may further include a at least one sensor of the sensor module 176, or a control circuit of the sensor module 176. In this case, the at least one sensor or the control circuit thereto may be embedded in a portion of the display module 380 (e.g., display 220 or DDIC 430) or a portion of the touch circuit 450.

For example, when the sensor module 176 embedded in the display module 380 includes a pressure sensor, the pressure sensor may acquire (e.g., receive) pressure information associated with the touch input through a portion or the entire area of the display 220.

According to an embodiment, the touch sensor 451 or the sensor module 176 may be arranged between pixels of a pixel layer of the display 220, or on or below the pixel layer.

According to another embodiment, the display module 380 may include the digitizer 460 to detect an input (e.g., touch input or hovering input) of the electronic pen (e.g., stylus pen). For example, the digitizer driving unit 470 that drives the digitizer 460 may be included as a component of the display module 380. For example, the digitizer driving unit 470 that drives the digitizer 460 may be included as a component separate from the display module 380. For example, the digitizer 460 may convert analog coordinates (e.g., location) of the electronic pen (e.g., stylus pen) to digital coordinate data. The digitizer 460 may deliver the digital coordinate data to a processor (e.g., processor 120 of FIG. 1 and/or DDIC 430).

According to an embodiment, the processor 320 (e.g., processor 120 of FIG. 1) may acquire (e.g., receive) the digital coordinate data that is input from the digitizer 460. The processor 320 may detect an input (e.g., touch input or hovering input) through the electronic pen (e.g., stylus pen) based on the digital coordinate data. For example, the digitizer 460 may include a plurality of x-axis channels and a plurality of y-axis channels. The processor 320 may sense a location of the electronic pen (e.g., stylus pen) using sensing signals (e.g., electro magnetic resonance (EMR) signals) received from the x-axis channels and the y-axis channels arranged in the digitizer 460. For example, the plurality of x-axis channels and the plurality of y-axis channels may be sequentially arranged in the digitizer 460, and the processor 320 may sense a location of the electronic pen (e.g., stylus pen) using sensing signals that are received from a plurality of consecutive channels (e.g., three adjacent channels).

The digitizer 460 may not be viewed from the outside due to the display 220, electronic parts, and mechanisms.

For example, the digitizer 460 may be arranged in the integrated form with a flat panel display or a flexible display. For example, the digitizer 460 may be arranged adjacent to the flat panel display or the flexible display. For example, when the digitizer 460 is applied to the display 220, the digitizer 460 may include a single electro magnetic resonance (EMR) sheet (or EMR film). The plurality of x-axis channels and the plurality of y-axis channels may be arranged on a single EMR sheet to detect the location of the electronic pen.

For example, the digitizer 460 may be arranged integrally with the flexible display (e.g., rollable display), or may be arranged adjacent to the flexible display. For example, the digitizer 460 may be arranged in a lower portion (e.g., bottom) of the display 220.

According to an embodiment, the electronic device 200 (e.g., wearable electronic device, smart watch) may further include an ultrasonic sensor (not shown) configured to identity touch of a user using ultrasonic waves and an ultrasonic sensor driving unit (not shown) configured to drive the ultrasonic sensor.

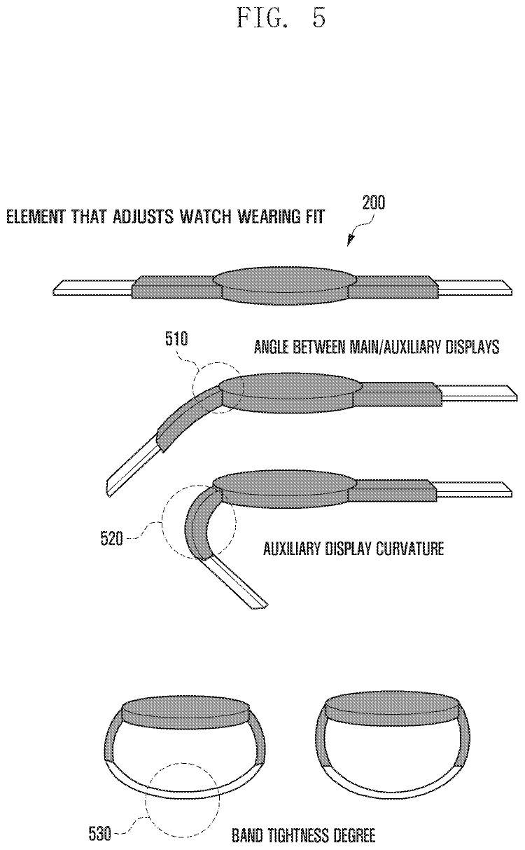

FIG. 5 illustrates an example of adjusting the tightness degree (e.g., loosening or tightening) when an electronic device (e.g., wearable electronic device, smart watch, smart band) is worn on the wrist of a user according to an embodiment of the disclosure.

Referring to FIG. 5, wearing of the electronic device (e.g., wearable electronic device, smart watch, smart band) may be adjusted to be loosened or tightened (e.g., adjust fit of wearable electronic device) according to the user's activity state and external environmental conditions.

According to an embodiment, the electronic device 200 (e.g., wearable electronic device, smart watch) may drive the first hinge driving module (e.g., first hinge driving module 231 of FIGS. 2A and 2B) to adjust the angle formed by the first housing (e.g., first housing 211 of FIGS. 2A and 2B, main housing) and the second housing (e.g., second housing 212 of FIGS. 2A and 2B, first sub-housing). The electronic device 200 (e.g., wearable electronic device, smart watch) may drive the second hinge driving module 232 to adjust the angle formed by the first housing 211 (e.g., main housing) and the third housing (e.g., third housing 213 of FIGS. 2A and 2B, second sub-housing). As illustrated in “510,” when the electronic device 200 is worn on the wrist of the user, the hinge (e.g., hinge 230 of FIGS. 2A and 2B) may be driven to adjust the angle of the housing (e.g., housing 210 of FIGS. 2A and 2B), thereby controlling the electronic device 200 to be worn loosely or to be worn tightly.

According to an embodiment, the electronic device 200 (e.g., wearable electronic device, smart watch) may adjust the bending curvature of the second display 222 (e.g., first sub-display, first sub-display area) such that the second display 222 (e.g., first sub-display, first sub-display area) has a curved shape (e.g., shape curved to fit shape of wrist). The electronic device 200 (e.g., wearable electronic device, smart watch) may adjust the bending curvature of the third display 223 (e.g., second sub-display, second sub-display area) such that the third display 223 (e.g., second sub-display, second sub-display area) has a flat shape. As illustrated in “520,” by adjusting the bending curvature of at least a portion of the display 220, the electronic device 200 may be adjusted to be worn loosely or to be worn tightly when the electronic device 200 is worn on the wrist of the user.

According to an embodiment, the electronic device 200 (e.g., wearable electronic device, smart watch) may adjust the angle of the housing (e.g., housing 210 of FIGS. 2A and 2B) and the bending curvature of at least a portion of the display 220, thereby controlling the electronic device 200 to be worn loosely or to be worn tightly (530).

According to an embodiment, the electronic device 200 (e.g., wearable electronic device, smart watch) may detect a state in which it is worn on the wrist of the user using the sensor module 176. The electronic device 200 (e.g., wearable electronic device, smart watch) may identify the activity state of the user using the sensor module 176 based on detecting the state in which it is worn on the wrist of the user. The electronic device 200 (e.g., wearable electronic device, smart watch) may adjust at least one of the angle between structures of the housing 210 and the bending curvature of the display (e.g., display 220 of FIGS. 2A and 2B) based on the change in the activity state of the user.

For example, changing the angle between the structures of the housing 210 may include operating the first hinge driving module (e.g., first hinge driving module 231 of FIGS. 2A and 2B) to change the angle between the first housing (e.g., first housing 211 of FIGS. 2A and 2B) and the second housing (e.g., second housing 212 of FIGS. 2A and 2B).

For example, changing the angle between the structures of the housing 210 may include operating the second hinge driving module (e.g., second hinge driving module 232 of FIGS. 2A and 2B) to change the angle between the first housing (e.g., first housing 211 of FIGS. 2A and 2B) and the third housing (e.g., third housing 213 of FIGS. 2A and 2B).

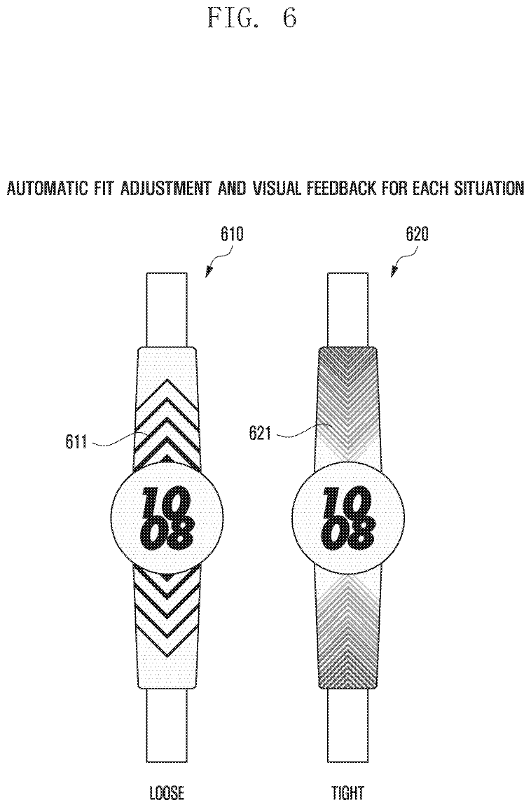

FIG. 6 illustrates an example of displaying (e.g., displaying visually) through a user interface that the tightness degree (e.g., loosening or tightening) of an electronic device (e.g., wearable electronic device, smart watch, smart band) is adjusted for each situation according to an embodiment of the disclosure.

Referring to FIG. 6, according to an embodiment, adjusting the fit of the electronic device 200 (e.g., wearable electronic device, smart watch) to be loosened may be displayed on the display (e.g., display 220 of FIGS. 2A and 2B). (610)

For example, a user interface 611 (or content) indicating that the fit is adjusted to be loosened may be displayed on the display 220, such that the user may intuitively recognize that the fit is automatically adjusted to be loosened depending on the situation.

According to an embodiment, the electronic device 200 (e.g., wearable electronic device, smart watch) may display that the fit is adjusted to be tightened (e.g., tight) on the display 220 (620).

For example, a user interface 621 (or content) indicating that the fit is adjusted to be tightened (e.g., tight) on the display 220, such that the user may intuitively recognize that the fit is adjusted to be tightened (e.g., tight) depending on the situation.

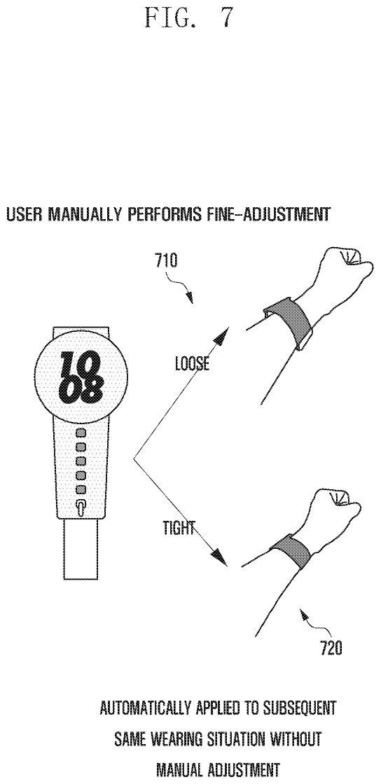

FIG. 7 illustrates an example of providing a function that allows a user to manually adjust the tightness degree (e.g., loosening or tightening) of an electronic device (e.g., wearable electronic device, smart watch) according to an embodiment of the disclosure.

Referring to FIG. 7, the electronic device 200 (e.g., wearable electronic device, smart watch) may provide a function capable of fine-adjusting the tightness degree (e.g., loosening or tightening) of the electronic device (e.g., wearable electronic device, smart watch).

According to an embodiment, when the user desires fine-adjustment of fit while the fit of the electronic device 200 (e.g., wearable electronic device, smart watch) is adjusted to a preset value, the tightness degree (e.g., loosening or tightening) of the electronic device (e.g., wearable electronic device, smart watch) may be finely adjusted.

For example, in a state in which fit of the electronic device 200 (e.g., wearable electronic device, smart watch) is adjusted to a preset value, the fit may be finely adjusted to be loosened by the user's selection on fine-adjustment (710).

In a state in which the fit of the electronic device 200 (e.g., wearable electronic device, smart watch) is adjusted to a preset value, the fit may be finely adjusted to be tightened (e.g., tight) by the user's selection on fine-adjustment (720).

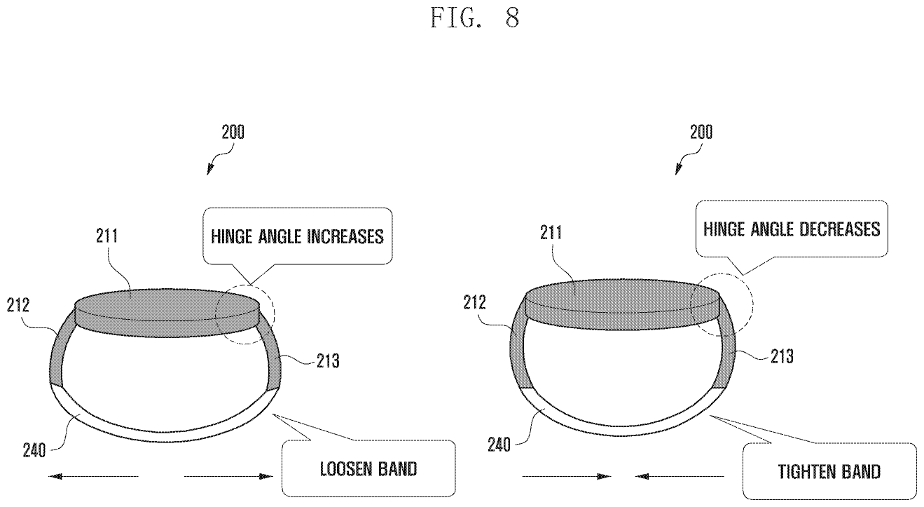

FIG. 8 illustrates an example of adjusting the tightness degree (e.g., loosening or tightening) of an electronic device (e.g., wearable electronic device, smart watch) due to the change in the angle of a hinge according to an embodiment of the Referring to FIG. 8, according to an embodiment, the electronic device 200 (e.g., wearable electronic device, smart watch) may adjust the angle of the housing (e.g., housing 210 of FIGS. 2A and 2B), thereby controlling the electronic device 200 to be worn loosely or to be worn tightly (e.g., tight).

For example, when the fit of the electronic device 200 is adjusted to be loosened, the length (e.g., width) of the band (e.g., fastening member 240) may be substantially increased. For example, when the fit of the electronic device 200 is adjusted to be tightened (e.g., tight), the length (e.g., width) of the band (e.g., fastening member 240) may be substantially decreased.

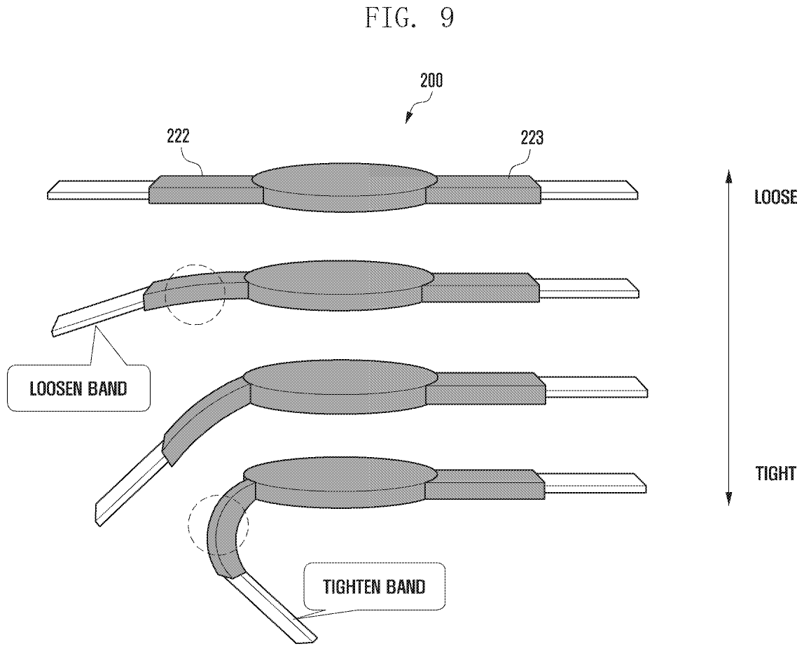

FIG. 9 illustrates an example of adjusting the tightness degree (e.g., loosening or tightening) of an electronic device (e.g., wearable electronic device, smart watch) due to the change in the bending curvature of a sub-display according to an embodiment of the disclosure.

Referring to FIG. 9, according to an embodiment, the electronic device 200 (e.g., wearable electronic device, smart watch) may adjust the bending curvature of the second display 222 (e.g., first sub-display, first sub-display area) and the third display 223 (e.g., second sub-display, second sub-display area), thereby controlling the electronic device 200 to be worn loosely or to be worn tightly (e.g., tight) according to an embodiment of the disclosure.

For example, when the fit of the electronic device 200 is adjusted to be loosened, the length (e.g., width) of the band (e.g., fastening member 240) may be substantially increased. For example, when the fit of the electronic device 200 is adjusted to be tightened (e.g., tight), the length (e.g., width) of the band (e.g., fastening member 240) may be substantially decreased.

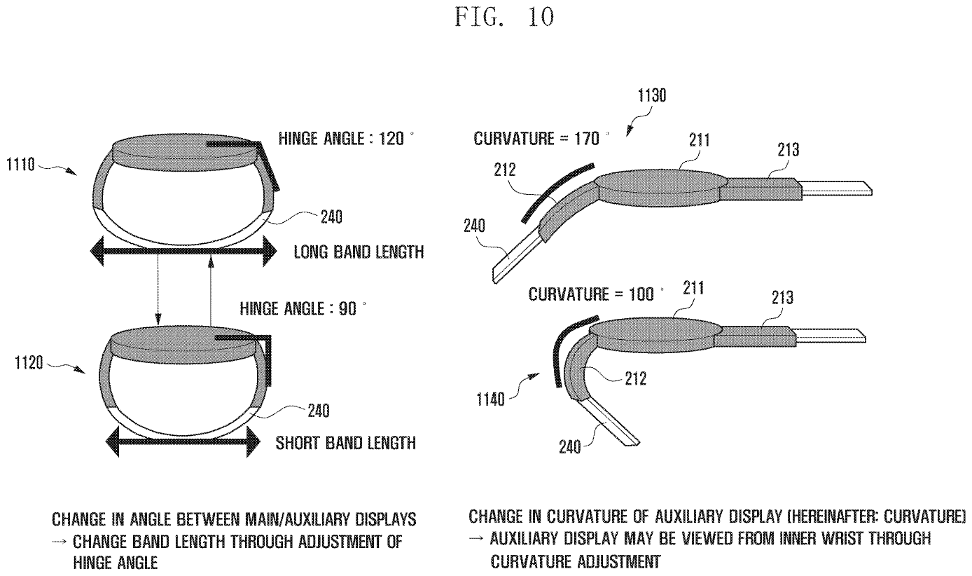

FIG. 10 illustrates an example of adjusting the tightness degree (e.g., loosening or tightening) of an electronic device (e.g., wearable electronic device, smart watch) due to the change in the angle of a hinge and the change in the bending curvature in a sub-display according to an embodiment of the disclosure.

Referring to FIG. 10, according to an embodiment, the electronic device 200 (e.g., wearable electronic device, smart watch) may adjust the angle of the housing (e.g., housing 210 of FIGS. 2A and 2B), thereby controlling the electronic device 200 to be worn loosely (1110), or to be worn tightly (1220). Along with adjusting the angle of the housing (e.g., housing 210 of FIGS. 2A and 2B), the electronic device 200 may adjust the bending curvature of the second display 222 (e.g., first sub-display, first sub-display area) and the third display 223 (e.g., second sub-display, second sub-display area), thereby controlling the electronic device 200 to be worn loosely (1130), or to be worn tightly (1140).

For example, when the fit of the electronic device 200 is adjusted to be loosened, the length (e.g., width) of the band (e.g., fastening member 240) may be substantially increased. For example, when the fit of the electronic device 200 is adjusted to be tightened (e.g., tight), the length (e.g., width) of the band (e.g., fastening member 240) may be substantially decreased.

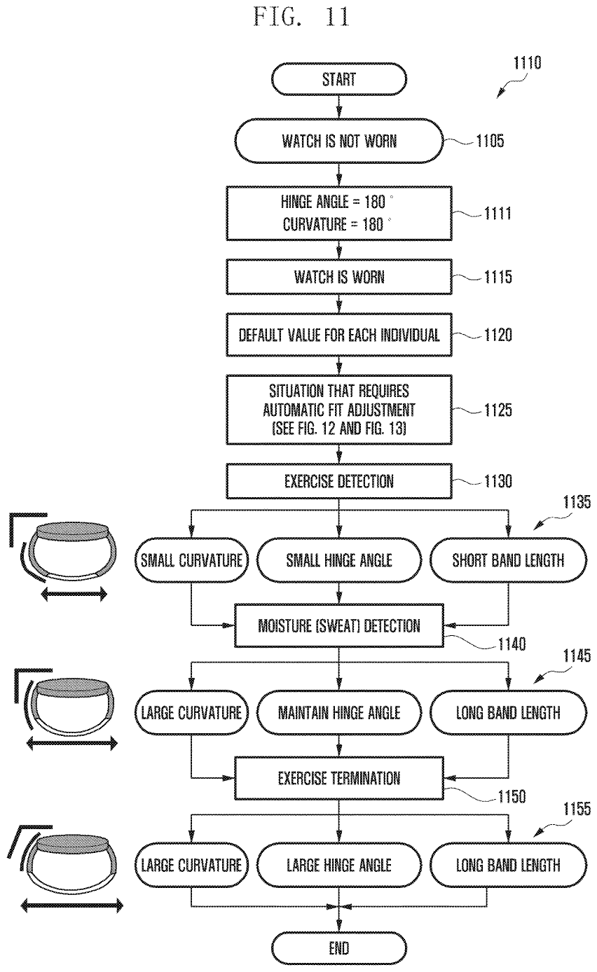

FIG. 11 is a flowchart illustrating an operating method of an electronic device (e.g., wearable electronic device, smart watch, smart band) according to an embodiment of the disclosure.

Referring to FIG. 11, according to an embodiment, the electronic device (electronic device 200 of FIGS. 2A and 3A) may operate a sensor module (e.g., sensor module 176 of FIG. 3A, sensor circuit) to determine whether the electronic device 200 (e.g., wearable electronic device, smart watch) is worn on a user's body (e.g., wrist).

According to an embodiment, a processor (e.g., processor 320 of FIG. 3A) according to an embodiment of the disclosure may operate the sensor module (e.g., sensor module 176 of FIG. 3A, sensor circuit) to determine whether the electronic device 200 (e.g., wearable electronic device, smart watch) is worn on the user's body (e.g., wrist).

According to another embodiment, when the electronic device 200 (e.g., wearable electronic device, smart watch) is not worn on the user's body (e.g., wrist) in operation 1105, the electronic device 200 may perform operation 1111.

According to an embodiment, when the electronic device 200 (e.g., wearable electronic device, smart watch) is not worn on the user's body (e.g., wrist) in operation 1105, the processor 320 may perform operation 1111.

In operation 1111, according to an embodiment, the electronic device 200 may adjust the angle of a hinge (e.g., hinge 230 of FIG. 2A) to the maximum (e.g., 180 degrees).

According to an embodiment, the electronic device 200 may adjust the curvature between a first display (e.g., first display 221 of FIG. 2A) and a second display (e.g., second display 222 of FIG. 2A) to the maximum (e.g., 180 degrees). The electronic device 200 may adjust the curvature between the first display 221 and a third display (e.g., third display 223 of FIG. 2A) to the maximum (e.g., 180 degrees).

In operation 1115, according to an embodiment, the electronic device 200 may operate the sensor module 176 (e.g., sensor circuit) to detect that the electronic device 200 (e.g., wearable electronic device, smart watch) is worn on the user's body (e.g., wrist).

According to an embodiment, the processor 320 may operate the sensor module 176 (e.g., sensor circuit) to detect that the electronic device 200 (e.g., wearable electronic device, smart watch) is worn on the user's body (e.g., wrist).

In operation 1120, according to an embodiment, the electronic device 200 may adjust the fit by optionally applying one of a plurality of fit values stored in memory (e.g., memory 330 of FIG. 3A).

According to an embodiment, the processor 320 may adjust the fit by optionally applying one of the plurality of fit values stored in the memory (e.g., memory 330 of FIG. 3A).

In operation 1125, according to an embodiment, the electronic device 200 may determine whether the fit needs to be adjusted.

According to an embodiment, the processor 320 may determine whether the fit needs to be adjusted.

In operation 1130, according to an embodiment, in the case of detecting an exercise state in which the fit needs to be adjusted, the electronic device 200 may apply a fit value suitable for an exercise mode.

According to an embodiment, in the case of detecting an exercise state in which the fit needs to be adjusted, the processor 320 may apply a fit value suitable for an exercise mode.

In operation 1135, the electronic device 200 may adjust the fit of the electronic device 200 to be tight to suit the exercise mode.

The processor 320 may adjust the fit of the electronic device 200 to be tight to suit the exercise mode.

In operation 1140, according to an embodiment, the electronic device 200 may measure moisture (e.g., sweat) by the user's exercise. For example, the electronic device 200 may measure moisture (e.g., sweat) by the user's exercise using a humidity sensor (e.g., humidity sensor 365 of FIG. 3A), and may acquire a humidity value. When the humidity value exceeds a reference value, the electronic device 200 may determine that the moisture has occurred on the user's body.

According to an embodiment, the processor 320 may measure moisture (e.g., sweat) by the user's exercise. For example, the processor 320 may measure moisture (e.g., sweat) by the user's exercise using the humidity sensor (e.g., humidity sensor of 365 FIG. 3A), and may acquire a humidity value. When the humidity value exceeds a reference value, the processor 320 may determine that the moisture has occurred on the user's body.

In operation 1145, according to an embodiment, when the measured moisture (e.g., sweat) exceeds the reference value as a result of measuring the moisture (e.g., sweat), the electronic device 200 may adjust the fit of the electronic device 200 to be loosened.

According to an embodiment, when the measured moisture (e.g., sweat) exceeds the reference value as a result of measuring the moisture (e.g., sweat), the processor 320 may adjust the fit of the electronic device 200 to be loosened.

In operation 1150, according to an embodiment, the electronic device 200 may operate the sensor module 176 (e.g., sensor circuit) to determine whether the user's exercise has terminated.

According to another embodiment, the processor 320 may operate the sensor module 176 (e.g., sensor circuit) to determine whether the user's exercise has terminated.

In operation 1155, according to an embodiment, the electronic device 200 may terminate the exercise mode according to termination of the user's exercise, and may adjust the fit of the electronic device 200 to be loose such that the moisture (e.g., sweat) may be easily evaporated (or removed).

According to an embodiment, the processor 320 may terminate the exercise mode according to termination of the user's exercise, and may adjust the fit of the electronic device 200 to be loose such that the moisture (e.g., sweat) may be easily evaporated (or removed).

As shown in Table 1 below, the electronic device 200 may adjust the angle of the hinge (e.g., hinge 230 of FIG. 2A) in three stages and may adjust the bending curvature of the display (e.g., display 220 of FIG. 2A) in three stages, thereby adjusting the fit of the electronic device 200 from a loose state to a tight state or from the tight state to the loose state in a total of nine stages

TABLE 1

Curvature of Auxiliary Display

| | | Small | Medium | Large |
|---|---|---|---|---|
| Hinge | Small | Very Tight | Tight | Medium |
| Angle | Medium | Tight | Medium | Loose |
| | Large | Medium | Loose | Very Loose |

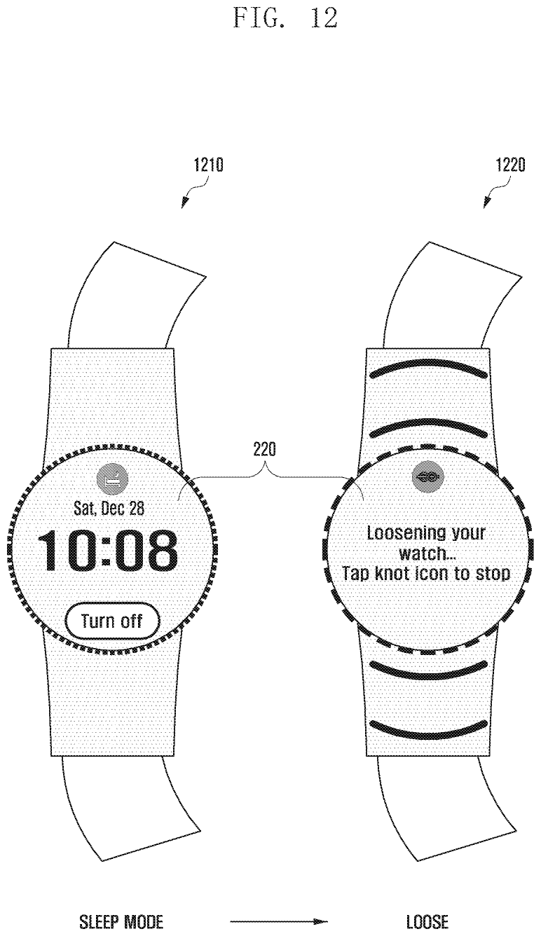

FIG. 12 illustrates an example of adjusting the tightness degree (e.g., loosening or tightening) of an electronic device (e.g., wearable electronic device, smart watch) in a sleep mode according to an embodiment of the disclosure.

Referring to FIG. 12, according to an embodiment, the electronic device 200 may determine whether the user is in a sleep state by operating the sensor module 176 (e.g., sensor circuit) to measure movement of the user. When the user is in the sleep state, the electronic device 200 may adjust the fit from a tight state 1210 to a loose state 1220 to suit a sleep mode. For example, the electronic device 200 may display a user interface (e.g., content) for releasing the sleep mode on the display 220 (e.g., display 220 of FIG. 2A) such that the user may release a sleep mode state and adjust the fit to another mode state.

According to an embodiment, the processor 320 may determine whether the user is in the sleep state by operating the sensor module 176 (e.g., sensor circuit) to measure movement of the user. When the user is in the sleep state, the processor 320 may adjust the fit from the tight state 1210 to the loose state 1220 to suit the sleep mode. For example, the processor 320 may display a user interface (e.g., content) for releasing the sleep mode on the display 220 (e.g., display 220 of FIG. 2A) such that the user may release a sleep mode state and adjust the fit to another mode state.

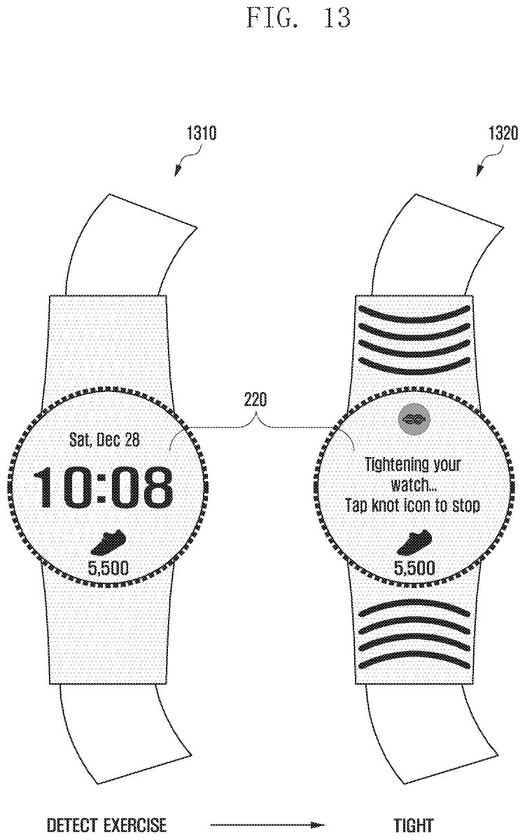

FIG. 13 illustrates an example of adjusting the tightness degree (e.g., loosening or tightening) of an electronic device (e.g., wearable electronic device, smart watch) in an exercise mode according to an embodiment of the disclosure.

Referring to FIG. 13, according to an embodiment, the electronic device 200 may determine whether the user is in an exercise state by operating the sensor module 176 (e.g., sensor circuit) to measure the movement of the user. When the user is in the exercise state, the electronic device 200 may adjust the fit from a loos state 1310 to a tight state 1320 to suit an exercise mode. For example, the electronic device 200 may display a user interface (e.g., content) for releasing the exercise mode on the display 220 (e.g., display 220 of FIG. 2A) such that the user may release an exercise mode state and adjust the fit to another mode state.

The processor 320 may determine whether the user is in the exercise state by operating the sensor module 176 (e.g., sensor circuit) to measure the movement of the user. When the user is in the exercise state, the processor 320 may adjust the fit from the loose state 1310 to the tight state 1320 to suit the exercise mode. For example, the processor 320 may display a user interface (e.g., content) for releasing the exercise mode on the display 220 (e.g., display 220 of FIG. 2A) such that the user may release an exercise mode state and adjust the fit to another mode state.

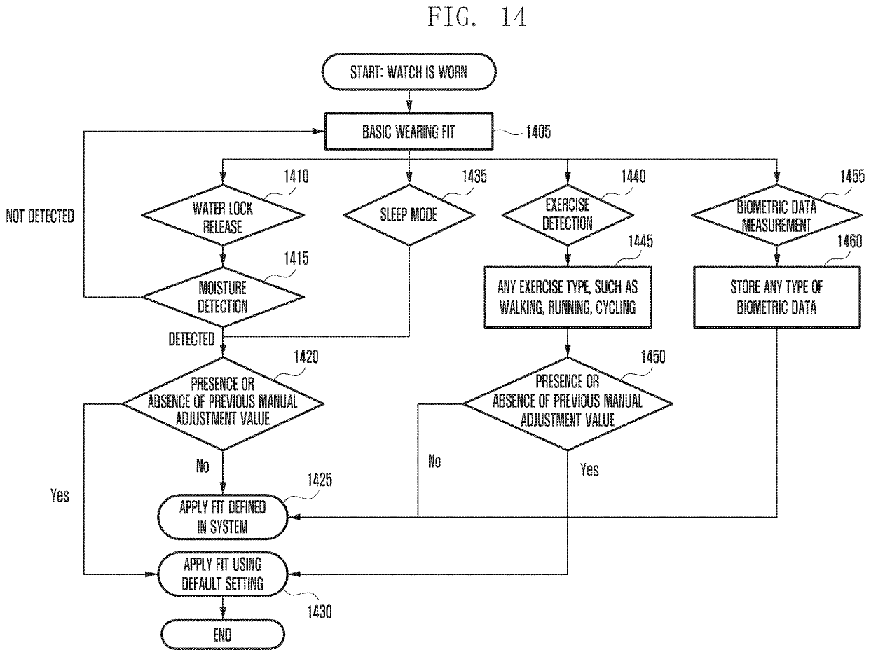

FIG. 14 is a flowchart illustrating an operating method of an electronic device (e.g., wearable electronic device, smart watch, smart band) according to an embodiment of the disclosure.

Referring to FIG. 14, according to an embodiment, the electronic device (e.g., electronic device 200 of FIGS. 2A and 3A) may operate a sensor module (e.g., sensor module 176 of FIG. 3A, sensor circuit) to determine whether the electronic device 200 is worn on the user's body (e.g., wrist).

According to an embodiment, a processor (e.g., processor 320 of FIG. 3A) may operate the sensor module 176 (e.g., sensor circuit) to determine whether the electronic device 200 is worn on the user's body (e.g., wrist).

In operation 1405, according to an embodiment, when the electronic device 200 is worn on the user's body (e.g., wrist), the electronic device 200 may apply the basic wearing fit.

According to an embodiment, when the electronic device 200 is worn on the user's body (e.g., wrist), the processor 320 may apply the basic wearing fit.

According to an embodiment, the electronic device 200 may operate the sensor module (e.g., sensor module 176 of FIG. 3A, sensor circuit) to determine the user's activity state (e.g., swimming, sleeping, exercising).

According to an embodiment, the processor 320 may operate the sensor module (e.g., sensor module 176 of FIG. 3A, sensor circuit) to determine the user's activity state (e.g., swimming, sleeping, exercising).

In operation 1410, according to an embodiment, the electronic device 200 may release water lock for moisture detection.

According to an embodiment, the processor 320 may release water lock for moisture detection.

In operation 1415, according to an embodiment, the electronic device 200 may detect the moisture.

In operation 1415, according to another embodiment, the processor 320 may detect the moisture.

When the moisture is detected in operation 1415, the electronic device 200 may perform operation 1420. When the moisture is not detected in operation 1415, the electronic device 200 may return to operation 1405 and may perform a next operation.

When the moisture is detected in operation 1415, the processor 320 may perform operation 1420. When the moisture is not detected in operation 1415, the processor 320 may return to operation 1405 and may perform a next operation.

In operation 1420, according to an embodiment, the electronic device 200 may determine whether there is a fine adjustment value of the fit that was manually adjusted by the user in the past.

According to an embodiment, the processor 320 may determine whether there is a fine adjustment value of the fit that was manually adjusted by the user in the past.

If there is no fine adjustment value of the fit that was manually adjusted by the user in the past as the determination result of operation 1420, the electronic device 200 may perform operation 1425. If there is the fine adjustment value of the fit that was manually adjusted by the user in the past, the electronic device 200 may perform operation 1430.

If there is no fine adjustment value of the fit that was manually adjusted by the user in the past as the determination result of operation 1420, the processor 320 may perform operation 1425. If there is the fine adjustment value of the fit that was manually adjusted by the user in the past, the processor 320 may perform operation 1430.

In operation 1425, according to an embodiment, the electronic device 200 may adjust the fit of the electronic device 200 by applying a fit value defined in the system (e.g., applying preset fit value).

According to an embodiment, the processor 320 may adjust the fit of the electronic device 200 by applying a fit value defined in the system (e.g., applying preset fit value).

In operation 1430, according to an embodiment, the electronic device 200 may adjust the fit of the electronic device 200 by applying the fine adjustment value of the fit that was manually adjusted by the user in the past.

The processor 320 may adjust the fit of the electronic device 200 by applying the fine adjustment value of the fit that was manually adjusted by the user in the past.

In operation 1435, according to an embodiment, the electronic device 200 may operate the sensor module 176 (e.g., sensor circuit) to identity a sleep state of the user. The electronic device 200 may adjust the fit of the electronic device 200 by applying a sleep mode. Then, the electronic device 200 may perform operation 1420 to operation 1430.

According to an embodiment, the processor 320 may operate the sensor module 176 (e.g., sensor circuit) to identity the sleep state of the user. The processor 320 may adjust the fit of the electronic device 200 by applying the sleep mode. Then, the processor 320 may perform operation 1420 to operation 1430.

In operation 1440, according to an embodiment, the electronic device 200 may operate the sensor module 176 (e.g., sensor circuit) to identify an exercise state of the user.

According to an embodiment, the processor 320 may operate the sensor module 176 (e.g., sensor circuit) to identify the exercise state of the user.

In operation 1445, according to an embodiment, the electronic device 200 may adjust the fit of the electronic device 200 by applying an exercise mode (e.g., walking, running, cycling).

The processor 320 may adjust the fit of the electronic device 200 by applying the exercise mode (e.g., walking, running, cycling).

In operation 1450, according to an embodiment, the electronic device 200 may determine whether there is a fine adjustment value of the fit that was manually adjusted by the user in the past.

According to an embodiment, the processor 320 may determine whether there is a fine adjustment value of the fit that was manually adjusted by the user in the past.

If there is no fine adjustment value of the fit that was manually adjusted by the user in the exercise mode in the past as the determination result of operation 1450, the electronic device 200 may perform operation 1425. If there is the fine adjustment value of the fit that was manually adjusted by the user in the exercise mode in the past, the electronic device 200 may perform operation 1430.

If there is no fine adjustment value of the fit that was manually adjusted by the user in the exercise mode in the past as the determination result of operation 1450, the processor 320 may perform operation 1425. If there is the fine adjustment value of the fit that was manually adjusted by the user in the exercise mode in the past, the processor 320 may perform operation 1430.

In operation 1425, according to an embodiment, the electronic device 200 may adjust the fit of the electronic device 200 by applying the fit value defined in the system (e.g., applying preset fit value).

According to an embodiment, the processor 320 may adjust the fit of the electronic device 200 by applying the fit value defined in the system (e.g., applying preset fit value).

In operation 1430, according to an embodiment, the electronic device 200 may adjust the fit of the electronic device 200 by applying a fine adjustment value of the fit that was manually adjusted by the user in the exercise mode in the past.

According to another embodiment, the processor 320 may adjust the fit of the electronic device 200 by applying the fine adjustment value of the fit that was manually adjusted by the user in the exercise mode in the past.

In operation 1455, according to an embodiment, the electronic device 200 may operate the sensor module 176 (e.g., sensor circuit) to measure biometric data of the user.

According to an embodiment, the processor 320 may operate the sensor module 176 (e.g., sensor circuit) to measure biometric data of the user.

In operation 1460, according to an embodiment, the electronic device 200 may store, in memory (e.g., memory 330 of FIG. 3A), the biometric data of the user acquired by operating the sensor module 176 (e.g., sensor circuit). For example, the electronic device 200 may adjust the fit of the electronic device 200 based on the biometric data of the user acquired by operating the sensor module 176 (e.g., sensor circuit). For example, the electronic device 200 may transmit the biometric data acquired by operating the sensor module 176 (e.g., sensor circuit) to an external electronic device (e.g., external smartphone, external server (e.g., server 108 of FIG. 1)).

The processor 320 store, in the memory (e.g., memory 330 of FIG. 3A), the biometric data of the user acquired by operating the sensor module 176 (e.g., sensor circuit). For example, the processor 320 may adjust the fit of the electronic device 200 based on the biometric data of the user acquired by operating the sensor module 176 (e.g., sensor circuit). For example, the processor 320 may transmit the biometric data acquired by operating the sensor module 176 (e.g., sensor circuit) to the external electronic device (e.g., external smartphone, external server (e.g., server 108 of FIG. 1)).

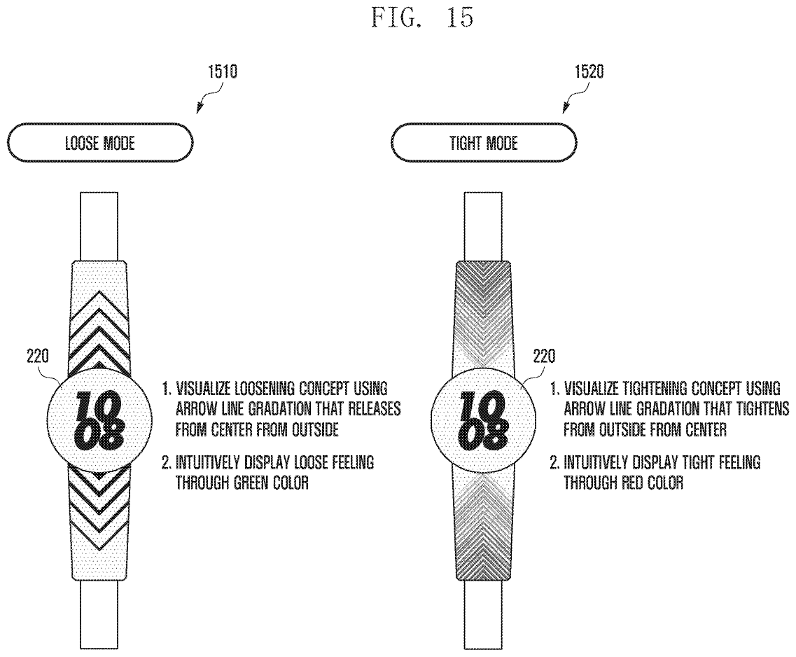

FIG. 15 illustrates an example of displaying (e.g., visually displaying) through a user interface that the tightness degree (e.g., loosening or tightening) of an electronic device (e.g., wearable electronic device, smart watch, smart band) is adjusted according to an embodiment of the disclosure.

Referring to FIG. 15, according to an embodiment, the electronic device (e.g., electronic device 200 of FIGS. 2A and 3A) (e.g., wearable electronic device, smart watch) may display on a display (e.g., display 220 of FIGS. 2A and 2B) that the fit is adjusted to be loose (1510).

For example, the user interface (or content) indicating that the fit is adjusted to be loose may be displayed on the display 220, such that the user may intuitively recognize the fit being adjusted to be loose automatically depending on the situation. For example, the electronic device 200 may visualize and display, on the display 220, the loosening concept using an arrow line gradation that releases from the center to the outside. For example, the electronic device 200 may display, on the display 220, a loosening feeling to be intuitively recognized by the user through a green color.

According to an embodiment, the electronic device 200 (e.g., wearable electronic device, smart watch) may display, on the display 220, that the fit is adjusted to be tight (e.g., tight) (1520).

In an example, the user interface (or content) indicating that the fit is adjusted to be tightened (e.g., tight) may be displayed on the display 220 such that the user may intuitively recognize the fit being adjusted to be tightened (e.g., tight) automatically depending on the situation. For example, the electronic device 200 may visualize and display, on the display 220, the tightening concept using an arrow line gradation that tightens from the outside to the center. For example, the electronic device 200 may display, on the display 220, a tightening feeling to be intuitively recognized by the user through a red color.

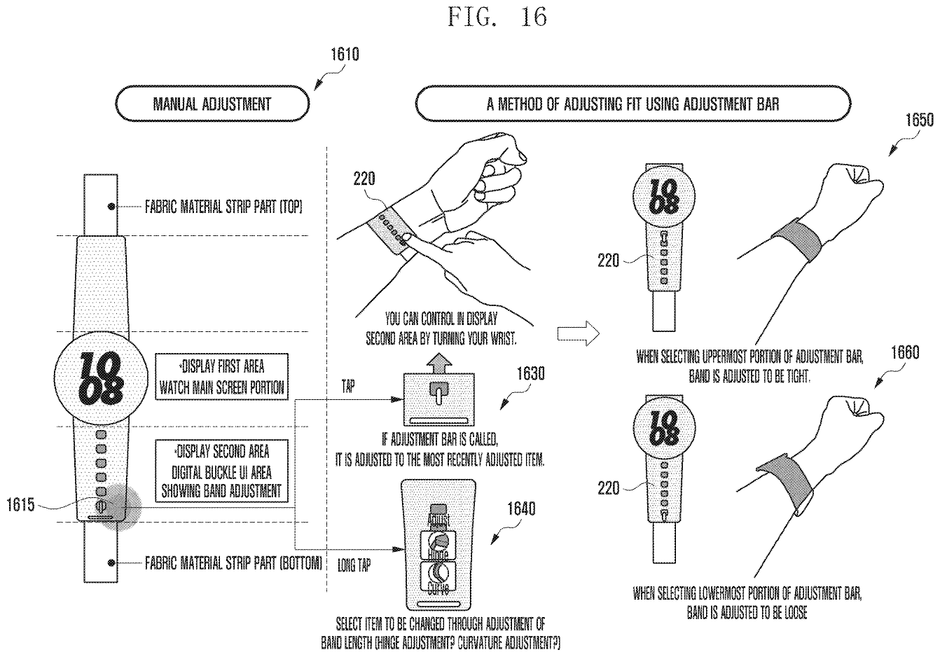

FIG. 16 illustrates an example of providing a fine adjustment menu such that a user may manually fine-adjust the tightness degree (e.g., loosening or tightening) of an electronic device (e.g., wearable electronic device, smart watch) according to an embodiment of the disclosure.

Referring to FIG. 16, according to an embodiment, after the fit of the electronic device 200 is adjusted to a preset value (e.g., default value for each mode), the electronic device 200 may provide a function capable of fine-adjusting the tightness degree (e.g., loosening or tightening).

According to an embodiment, when the user desires fine-adjustment of the fit while the fit of the electronic device 200 (e.g., wearable electronic device, smart watch) is adjusted to a preset value, the tightness degree (e.g., loosening or tightening) may be finely adjusted by operating in a manual fit mode (1610).

According to an embodiment, the electronic device 200 may display a fit adjustment bar menu 1615 (e.g., digital buckle user interface) to enable fine-adjustment of the tightness degree (e.g., loosening or tightening).

According to another embodiment, if the fit adjustment bar menu 1615 (e.g., digital buckle user interface) is activated and the user short-touches the fit adjustment bar menu 1615 (e.g., digital buckle user interface), the user may adjust the fit with a recently adjusted item (e.g., finely adjusted fit value) (1630).

According to an embodiment, if the fit adjustment bar menu 1615 (e.g., digital buckle user interface) is activated and the user long-touches the fit adjustment bar menu 1615 (e.g., digital buckle user interface), the fit adjustment bar menu 1615 (e.g., digital buckle user interface) may be displayed to allow new fine adjustment (1640).

In a state in which the fit of the electronic device 200 (e.g., wearable electronic device, smart watch) is adjusted to a preset value, the fit may be finely adjusted to be tightened (e.g., tight) by the user's selection on fine-adjustment (1650). For example, if the uppermost part of the fit adjustment bar menu 1615 (e.g., digital buckle user interface) is touched, the fit of the electronic device 200 may be adjusted to be most tightened (e.g., tight).

According to an embodiment, in a state in which the fit of the electronic device 200 (e.g., wearable electronic device, smart watch) is adjusted to a preset value, the fit may be finely adjusted to be loose by the user's selection on fine adjustment (1660). For example, if a lowermost portion of the fit adjustment bar menu 1615 (e.g., digital buckle user interface) is touched, the fit of the electronic device 200 may be adjusted to be most loose.

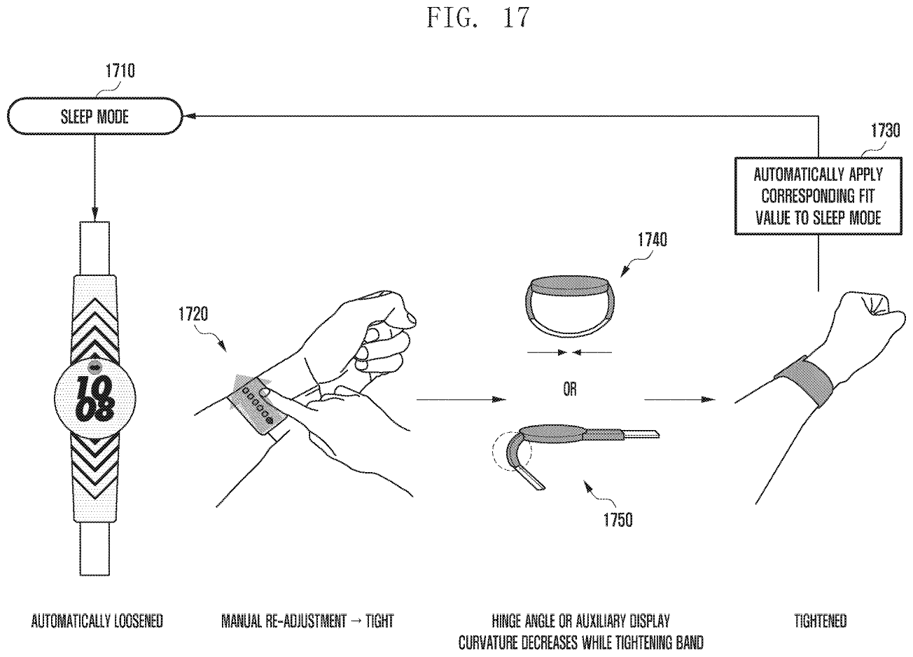

FIG. 17 illustrates an example of storing a fine adjustment value of the tightness degree (e.g., loosening or tightening) of an electronic device (e.g., wearable electronic device, smart watch) applied by a user, and automatically adjusting the tightness degree (e.g., loosening or tightening) of the electronic device (e.g., wearable electronic device, smart watch) using the fine adjustment value under the same conditions according to an embodiment of the disclosure.

Referring to FIG. 17, the electronic device (e.g., electronic device 200 of FIGS. 2A and 3A) may operate a sensor module (e.g., sensor module 176 of FIG. 3A, sensor circuit) to measure movement of the user.

According to an embodiment, when the user is in a sleep state, the electronic device 200 may operate in a sleep mode (1710) to adjust the fit of the electronic device 200.

According to an embodiment, for example, when the user desires fine adjustment of the fit while the user is in the sleep mode state, the electronic device 200 may operate in a manual fit mode to fine-adjust the tightness degree (e.g., loosening or tightening) (1720).

In an example, the fit of the electronic device 200 may be adjusted by adjusting the angle of a hinge (e.g., hinge 230 of FIG. 2A) of the electronic device 200 (1740).

For example, the fit of the electronic device 200 may be adjusted by adjusting the bending curvature of a display (e.g., display 220 of FIG. 2A) of the electronic device 200 (1750).

For example, the electronic device 200 may store a fine adjustment value used to fine-adjust the fit of the electronic device 200 in the sleep mode in the memory (e.g., memory 330 of FIG. 3A). The electronic device 200 may acquire the fine adjustment value in the sleep mode stored in the memory (e.g., memory 330 of FIG. 3A) when applying to the sleep mode later, and may adjust the fit by applying the fine adjustment value in the sleep mode (1730).

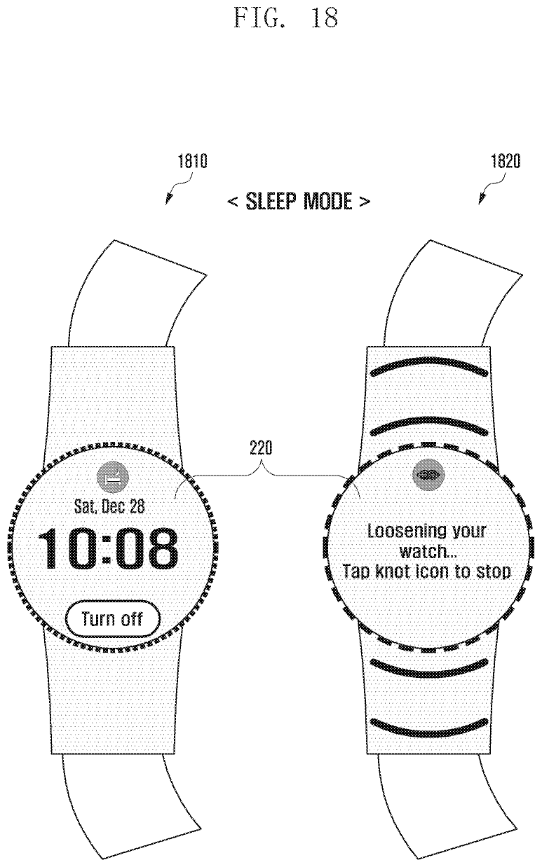

FIG. 18 illustrates an example of providing a function capable of releasing the tightness degree (e.g., loosening or tightening) of an automatically adjusted electronic device (e.g., wearable electronic device, smart watch) in a sleep mode according to an embodiment of the disclosure.

Referring to FIG. 18, according to an embodiment, the electronic device (e.g., electronic device 200 of FIGS. 2A and 3A) may determine whether the user is in a sleep state by operating a sensor module (e.g., sensor module 176 of FIG. 3A, sensor circuit) to measure the movement of the user. When the user is in the sleep state, the electronic device 200 may adjust the fit from a tight state 1810 to a loose state 1820 to suit the sleep mode.

According to an embodiment, the processor 320 (e.g., processor 320 of FIG. 3A) may determine whether the user is in the sleep state by operating the sensor module (e.g., sensor module 176 of FIG. 3A, sensor circuit) to measure the movement of the user. When the user is in the sleep state, the processor 320 may adjust the fit from the tight state 1810 to the loose state 1820 to suit the sleep mode.

According to another embodiment, the electronic device 200 may display a user interface (e.g., content) for releasing the sleep mode on the display 220, such that the user may release a sleep mode state and adjust the fit to another mode state.

According to an embodiment, the processor 320 may display a user interface (e.g., content) for releasing the sleep mode on the display 220, such that the user may release a sleep mode state and adjust the fit to another mode state.

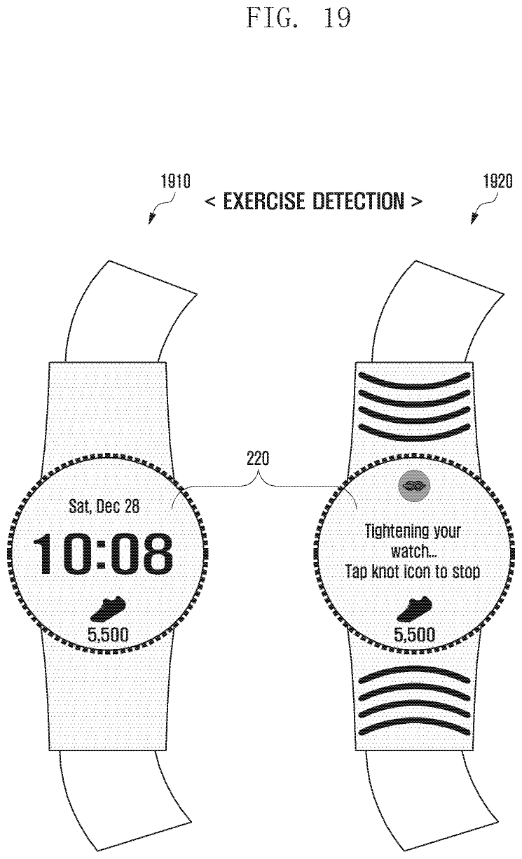

FIG. 19 illustrates an example of providing a function capable of releasing the tightness degree (e.g., loosening or tightening) of an automatically adjusted electronic device (e.g., wearable electronic device, smart watch) in an exercise mode according to an embodiment of the disclosure.

Referring to FIG. 19, according to an embodiment, the electronic device (e.g., electronic device 200 of FIGS. 2A and 3A) may determine whether the user is in an exercise state by operating the sensor module (e.g., sensor module 176 of FIG. 3A, sensor circuit) to measure the movement of the user. When the user is in the exercise state, the electronic device 200 may adjust the fit from a loose state 1910 to a tight state 1920 to suit the exercise mode.

According to an embodiment, the processor 320 (e.g., processor 320 of FIG. 3A) may determine whether the user is in the exercise state by operating the sensor module (e.g., sensor module 176 of FIG. 3A, sensor circuit) to measure the movement of the user. When the user is in the exercise state, the processor 320 may adjust the fit from the loose state 1910 to the tight state 1920 to suit the exercise mode.

the electronic device 200 may display a user interface (e.g., content) for releasing the exercise mode on the display 220 (e.g., display 220 of FIG. 2A) such that the user may release an exercise mode state and adjust the fit to another mode state.

According to an embodiment, the processor 320 may display a user interface (e.g., content) for releasing the exercise mode on the display 220 (e.g., display 220 of FIG. 2A) such that the user may release an exercise mode state and adjust the fit to another mode state.

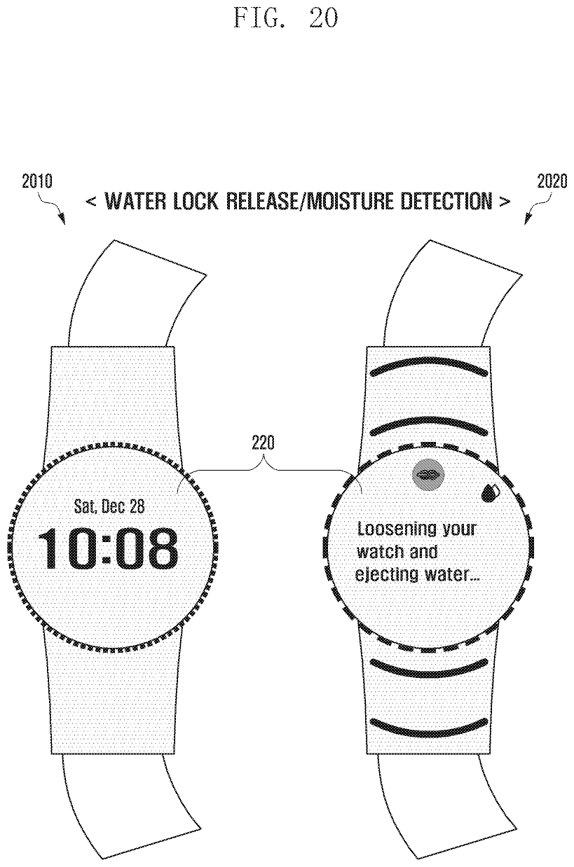

FIG. 20 illustrates an example of providing a function capable of releasing the tightness degree (e.g., loosening or tightening) of an automatically adjusted electronic device (e.g., wearable electronic device, smart watch) in a swimming mode according to an embodiment of the disclosure.

Referring to FIG. 20, according to an embodiment, the electronic device (e.g., electronic device 200 of FIGS. 2A and 3A) may operate the sensor module (e.g., sensor module 176 of FIG. 3A, sensor circuit) to measure the movement of the user and humidity. The electronic device 200 may release water lock for measuring the humidity, and may adjust the fit from a tight state 2010 to a loose state 2020 to suit a water lock mode.

According to an embodiment, the processor 320 (e.g., processor 320 of FIG. 3A)) may operate the sensor module (e.g., sensor module 176 of FIG. 3A, sensor circuit) to measure the movement of the user and humidity. The electronic device 200 may release water lock for measuring the humidity, and may adjust the fit from the tight state 2010 to the loose state 2020 to suit the water lock mode.

the electronic device 200 may display a user interface (e.g., content) for releasing the water lock mode on the display 220 such that the user may release the water lock mode and adjust the fit to another mode state.

According to an embodiment, the processor 320 may display a user interface (e.g., content) for releasing the water lock mode on the display 220 such that the user may release the water lock mode and adjust the fit to another mode state.

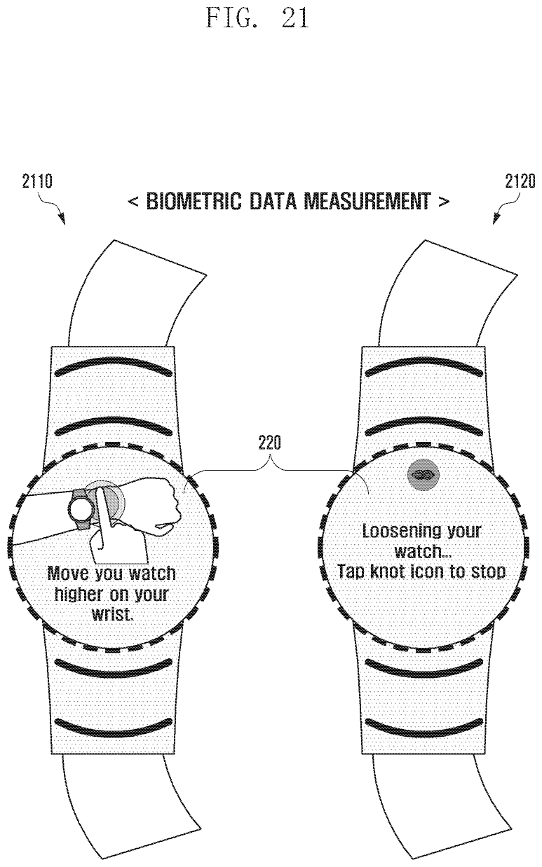

FIG. 21 illustrates an example of providing a function capable of releasing the tightness degree (e.g., loosening or tightening) of an automatically adjusted electronic device (e.g., wearable electronic device, smart watch) in a biometric data (e.g., biometric information) measurement mode according to an embodiment of the Referring to FIG. 21, according to an embodiment, the electronic device 200 may operate the sensor module (e.g., sensor module 176 of FIG. 3A, sensor circuit) to measure biometric data of the user.

For example, the electronic device 200 may display a user interface (e.g., content) for guiding the user's body motion on the display 220, such that biometric measurement of the user may be smoothly performed.

For example, the electronic device 200 may display a user interface (e.g., content) for releasing a biometric data measurement mode such that the user may release the biometric data measurement mode and may adjust the fit to another mode state.

According to an embodiment, the processor 320 may operate the sensor module 176 (e.g., sensor circuit) to measure biometric data of the user.

For example, the processor 320 may display a user interface (e.g., content) for guiding the user's body motion on the display 220, such that biometric measurement of the user may be smoothly performed.

For example, the processor 320 may display a user interface (e.g., content) for releasing a biometric data measurement mode such that the user may release the biometric data measurement mode and may adjust the fit to another mode state.

According to another embodiment, the electronic device 200 may store the biometric data of the user acquired by operating the sensor module 176 (e.g., sensor circuit) in the memory (e.g., memory 330 of FIG. 3A).

According to an embodiment, the processor 320 may store the biometric data of the user acquired by operating the sensor module 176 (e.g., sensor circuit) in the memory (e.g., memory 330 of FIG. 3A).

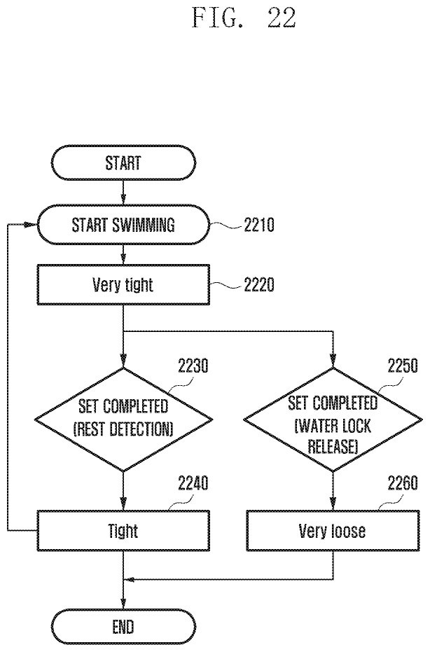

FIG. 22 is a flowchart illustrating an operating method of an electronic device (e.g., wearable electronic device, smart watch, smart band) according to an embodiment of the disclosure.

Referring to FIG. 22, according to an embodiment, in operation 2210, the electronic device (e.g., electronic device 200 of FIGS. 2A and 3A) may determine whether the user is in a swimming state by operating a sensor module (e.g., sensor module 176 of FIG. 3A, sensor circuit) to measure the movement of the user.

According to an embodiment, a processor (e.g., processor 320 of FIG. 3A) may determine whether the user is in the swimming state by operating the sensor module 176 (e.g., sensor circuit) to measure the movement of the user.

In operation 2220, according to an embodiment, when the user is in the swimming state, the electronic device 200 may adjust the fit to suit a swimming mode. For example, when the user is in the swimming state, the electronic device 200 may adjust the fit of the electronic device 200 to be very strongly tightened (e.g., very tight) by applying a most strongly tightening fit value among nine fit values listed in Table 1.

According to another embodiment, when the user is in the swimming state, the processor 320 may adjust the fit to suit the swimming mode. For example, when the user is in the swimming state, the processor 320 may adjust the fit of the electronic device 200 to be very strongly tightened (e.g., very tight) by applying a most strongly tightening fit value among nine fit values listed in Table 1.

In operation 2230, according to an embodiment, the electronic device 200 may determine whether the user has terminated swimming exercise by operating the sensor module 176 (e.g., sensor circuit) to measure the movement of the user.

According to an embodiment, the processor 320 may determine whether the user has terminated swimming exercise by operating the sensor module 176 (e.g., sensor circuit) to measure the movement of the user.

In operation 2240, according to an embodiment, when swimming of the user is terminated, the electronic device 200 may adjust the fit to the “tight” fit, which is one stage looser than the “very tight” fit applied in the swimming mode.

According to an embodiment, when swimming of the user is terminated, the processor 320 may adjust the fit to the “tight” fit, which is one stage looser than the “very tight” fit applied in the swimming mode.

In operation 2250, according to an embodiment, when swimming of the user is terminated, the electronic device 200 may release water lock.

When swimming of the user is terminated, the processor 320 may release water lock.

In operation 2260, according to an embodiment, the electronic device 200 may adjust the fit of the electronic device 200 to be very loose by applying a very loose fit value among nine fit values listed in Table 1, such that the humidity may be quickly removed.

According to an embodiment, the processor 320 may adjust the fit of the electronic device 200 to be very loose by applying a very loose fit value among nine fit values listed in Table 1, such that the humidity may be quickly removed.

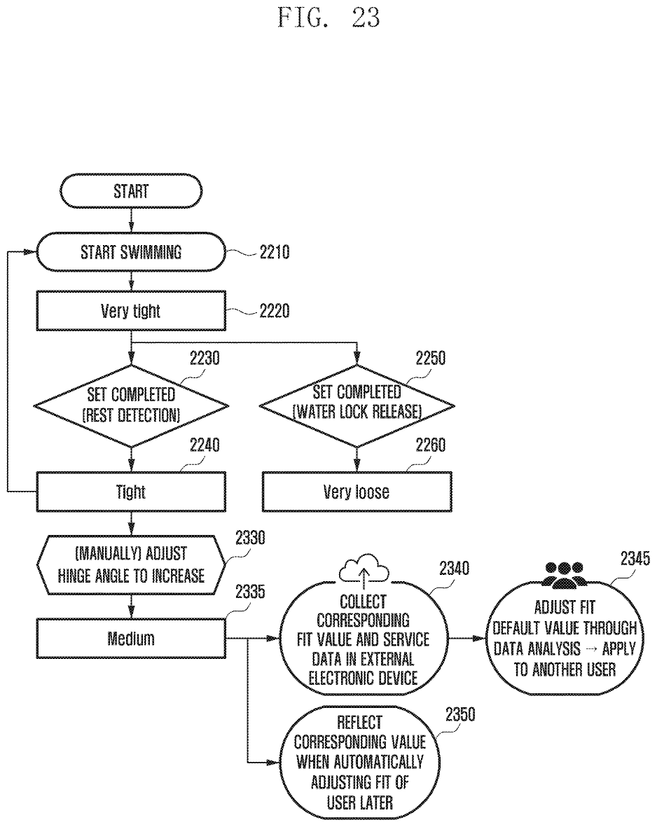

FIG. 23 is a flowchart illustrating an operating method of an electronic device (e.g., wearable electronic device, smart watch, smart band) according to an embodiment of the disclosure.

In describing the operating method of the electronic device illustrated in FIG. 23, the detailed description of the operating method that is identical (or similar) to the operating method of the electronic device illustrated in FIG. 22 may be omitted.

Referring to FIG. 23, according to an embodiment, the electronic device (e.g., electronic device 200 of FIGS. 2A and 3A, wearable electronic device, smart watch) according to an embodiment of the disclosure may operate in conjunction with an external electronic device (e.g., external server (e.g., server 108 of FIG. 1), smartphone, tablet PC, laptop PC) and/or an external wearable electronic device (e.g., audio electronic device, wireless earphone).

In operation 2330, according to an embodiment, after the swimming mode is terminated, the electronic device 200 may adjust the angle of the hinge (e.g., hinge 230 of FIG. 2A) to increase.

According to an embodiment, after the swimming mode is terminated, the processor (e.g., processor 320 of FIG. 3A) may adjust the angle of the hinge 230 to increase.

In operation 2335, according to an embodiment, the fit of the electronic device 200 may be adjusted to be loose (e.g., medium in Table 1). For example, after the swimming mode is terminated, the fit of the electronic device 200 may be adjusted to be loose (e.g., medium in Table 1) by adjusting the angle of the hinge 230 to increase in a manual mode according to the user's selection.

In operation 2340, according to an embodiment, the electronic device 200 may store a fit value adjusted by the user in the memory (e.g., memory 330 of FIG. 3A). For example, the electronic device 200 may transmit the fit value adjusted by the user to an external electronic device (e.g., external smartphone). For example, the electronic device 200 may transmit the fit value adjusted by the user to an external server (e.g., server 108 of FIG. 1).

In operation 2345, according to an embodiment, the external electronic device (e.g., external smartphone) may analyze the fit value adjusted by the user, acquired from the electronic device 200. The external electronic device (e.g., external smartphone) may provide the fit value adjusted by the user to an electronic device of another user such that the fit value adjusted by the user, acquired from the electronic device 200, may be applied to the other user.

In operation 2350, when a state identical to a state in which the fit value adjusted by the user is applied occurs later, the electronic device 200 may apply the fit value adjusted by the user.

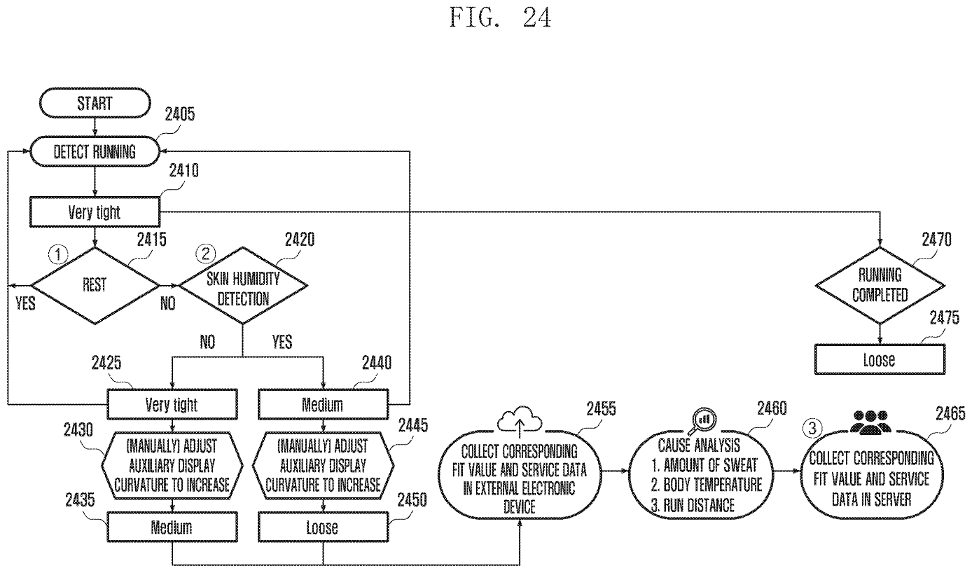

FIG. 24 is a flowchart illustrating an operating method of an electronic device (e.g., wearable electronic device, smart watch, smart band) according to an embodiment of the disclosure.

Referring to FIG. 24, the electronic device (e.g., electronic device 200 of FIGS. 2A and 3A, wearable electronic device, smart watch) according to an embodiment of the disclosure may operate in conjunction with an external electronic device (e.g., external server (e.g., server of FIG. 1)), smartphone, tablet PC, laptop PC) and/or an external wearable electronic device (e.g., audio electronic device, wireless earphone).

According to an embodiment, in operation 2405, the electronic device (e.g., electronic device 200 of FIGS. 2A and 3A) may determine whether the user is in a state of exercise (e.g., running) by operating a sensor module (e.g., sensor module 176 of FIG. 3A, sensor circuit) to measure the movement of the user.

According to another embodiment, a processor (e.g., processor 320 of FIG. 3A) may determine whether the user is in the state of exercise (e.g., running) by operating the sensor module (e.g., sensor module 176 of FIG. 3A, sensor circuit) to measure the movement of the user.

In operation 2410, according to an embodiment, when the user is in the state of exercise (e.g., running), the electronic device 200 may adjust the fit to suit an exercise (e.g., running) mode. For example, when the user is in the state of exercise (e.g., running), the electronic device 200 may adjust the fit of the electronic device 200 to be very strongly tightened (e.g., very tight) by applying the most strongly tightening fit value among nine fit values listed in Table 1.

According to an embodiment, when user is in the state of exercise (e.g., running), the processor 320 may adjust the fit to suit an exercise (e.g., running) mode. For example, when the user is in the state of exercise (e.g., running), the processor 320 may adjust the fit of the electronic device 200 to be very strongly tightened (e.g., very tight) by applying the most strongly tightening fit value among nine fit values listed in Table 1.

In operation 2415, according to an embodiment, the electronic device 200 may determine whether the user is resting by operating the sensor module 176 (e.g., sensor circuit) to measure the movement of the user.

According to an embodiment, the processor 320 may determine whether the user is resting by operating the module (sensor module 176 (e.g., sensor circuit)) to measure the movement of the user.

If the user is resting as the determination result of operation 2415, subsequent operations may be performed by returning to operation 2405.

Unless the user is resting as the determination result of operation 2415, operation 2420 may be performed.

In operation 2420, according to an embodiment, the electronic device 200 may detect the skin humidity of the user by operating the module (sensor module 176 (e.g., sensor circuit)).

According to an embodiment, the electronic device 200 may detect skin humidity of the user by operating the module (the sensor module 176 (e.g., sensor circuit)).

Unless the skin humidity of the user does not exceed a reference value, operation 2425 may be performed.

According to an embodiment, if the skin humidity of the user exceeds a reference value, operation 2440 may be performed.

In operation 2425, according to an embodiment, the electronic device 200 may adjust the fit to “very tight” in Table 1 since the humidity does not exceed the reference value.

According to an embodiment, since the humidity does not exceed the reference value, the processor 320 may adjust the fit to “very tight” in Table 1.

In operation 2430, when the user manually fine-adjusts a fit value, the electronic device 200 may adjust the bending curvature of the first display (e.g., first display 222 of FIG. 2A) and the second display (e.g., second display 223 of FIG. 2A) in the display (e.g., display 220 of FIG. 2A) to increase according to the user's fine-adjustment for the fit value.

According to an embodiment, the processor 320 may adjust the bending curvature of the first display 221 and the second display 222 in the display 220 to increase according to the user's fine-adjustment for the fit value.

In operation 2435, according to an embodiment, the electronic device 200 may adjust the fit of the electronic device 200 to be looser than a previous state by applying a medium fit value (medium) among nine fit values listed in Table 1, such that the humidity may be quickly removed.

According to an embodiment, the processor 320 may adjust the fit of the electronic device 200 to be looser than a previous state by applying a medium fit value (medium) among nine fit values listed in Table 1, such that the humidity may be quickly removed.

In operation 2440, according to an embodiment, since the humidity exceeds the reference value, the electronic device 200 may adjust the fit to “medium” in Table 1 such that the humidity may be quickly removed.

According to another embodiment, since the humidity exceeds a reference value, the processor 320 may adjust the fit to “medium” in Table 1 such that the humidity may be quickly removed.

In operation 2445, when the user manually fine-adjusts the fit value, the electronic device 200 may adjust the bending curvature of the first display 221 and the second display 222 in the display 220 to increase in accordance with the user's fine-adjustment for the fit value.

According to an embodiment, when the user manually fine-adjusts the fit value, the processor 320 may adjust the bending curvature of the first display 221 and the second display 222 in the display 220 to increase in accordance with the user's fine-adjustment for the fit value.

In operation 2450, according to an embodiment, the electronic device 200 may adjust the fit of the electronic device 200 to be looser than a previous state by applying a loose fit value (loose) among nine fit values listed in Table 1, such that the humidity may be quickly removed.

According to an embodiment, the processor 320 may adjust the fit of the electronic device 200 to be looser than a previous state by applying a loose fit value (loose) among nine fit values listed in Table 1, such that the humidity may be quickly removed.

In operation 2455, according to an embodiment, the electronic device 200 may store the fit value adjusted by the user in the memory (e.g., memory 330 of FIG. 3A). For example, the electronic device 200 may transmit the fit value adjusted by the user to the external electronic device (e.g., external smartphone). For example, the electronic device 200 may transmit the fit value adjusted by the user to the external server (e.g., server 108 of FIG. 1).

In operation 2460, according to an embodiment, the external electronic device (e.g., external smartphone) may analyze the fit value adjusted by the user, acquired from the electronic device 200. For example, the external electronic device may analyze the amount of sweat generated on the skin of the user, the user's body temperature, and the distance the user has run, and may analyze the cause of the user's skin humidity that exceeds the set humidity

In operation 2465, according to an embodiment, the analysis result of the cause of the user's skin humidity may be provided to the external server (e.g., server 108 of FIG. 1).

The external server 108 may provide the fit value adjusted by the user to an electronic device of another user, such that the fit value adjusted by the user, acquired from the electronic device 200, may be applied to the other user.

In operation 2470, according to an embodiment, the electronic device 200 may determine whether exercise (e.g., running) is completed by operating the sensor module 176 (e.g., sensor circuit) to measure the movement of the user.

According to an embodiment, the processor 320 may determine whether exercise (e.g., running) is completed by operating the sensor module 176 (e.g., sensor circuit) to measure the movement of the user.

In operation 2475, According to an embodiment, when the user's exercise (e.g., running) is completed, the electronic device 200 may adjust the fit to be loose.

According to an embodiment, when the user's exercise (e.g., running) is completed, the processor 320 may adjust the fit to be loose.

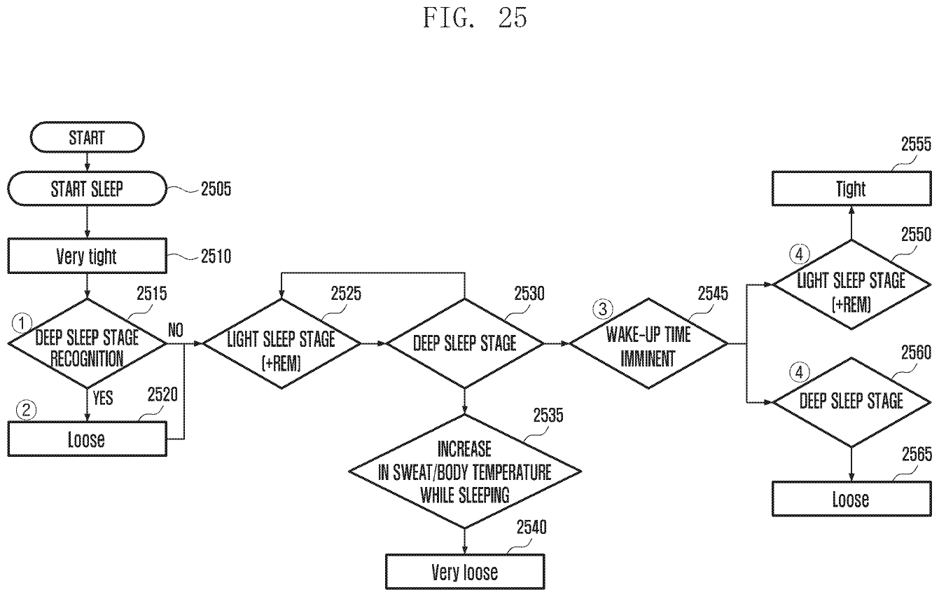

FIG. 25 is a flowchart illustrating an operating method of an electronic device (e.g., wearable electronic device, smart watch, smart band) according to an embodiment of the disclosure.

Referring to FIG. 25, in operation 2505, according to an embodiment, the electronic device (e.g., electronic device 200 of FIGS. 2A and 3A) may determine whether the user is in a sleep state by operating a sensor module (e.g., sensor module 176 of FIG. 3A, sensor circuit) to measure the movement of the user.

According to an embodiment, a processor (e.g., processor 320 of FIG. 3A) may determine whether the user is in the sleep state by operating the sensor module 176 (e.g., sensor circuit) to measure the movement of the user.

In operation 2510, according to an embodiment, when the user is in the sleep state, the electronic device 200 may adjust the fit to a tight state to suit a sleep mode.

When the user is in the sleep state, the processor 320) may adjust the fit to a tight state to suit the sleep mode.

In operation 2515, according to an embodiment, the electronic device 200 may determine whether the user is in a deep sleep state by operating the sensor module 176 (e.g., sensor circuit).

According to an embodiment, the processor 320 may determine whether the user is in the deep sleep state by operating the sensor module 176 (e.g., sensor circuit).

When the user is in the deep sleep state as the determination result of operation 2515, operation 2520 may be performed.

When the user is not in the deep sleep state as the determination result of operation 2515, operation 2525 may be performed.

In operation 2520, according to an embodiment, the electronic device 200 may adjust the fit to be loose to suit a deep sleep mode, and may adjust the fit to be loose to prevent the user from waking up during deep sleep. Here, the fit may be adjusted to be loose at a level at which the sensor module 176 may smoothly measure the user's movement and heart rate.

According to an embodiment, the processor 320 may adjust the fit to be loose to suit the deep sleep mode, and may adjust the fit to be loose to prevent the user from waking up during deep sleep. Here, the fit may be adjusted to be loose at a level at which the sensor module 176 may smoothly measure the user's movement and heart rate.

In operation 2525, according to an embodiment, the electronic device 200 may identify whether the user changes from a light sleep state to a deep sleep state in operation 2530.

According to an embodiment, the processor 320 may identify whether the user changes from the light sleep state to the deep sleep state in operation 2530.

In operation 2535, according to an embodiment, when the user changes to the deep sleep state, the electronic device 200 may determine whether the user's physical ecology has changed by operating the sensor module 176 (e.g., sensor circuit). For example, the electronic device 200 may determine whether the user sweating has increased or whether the user's body temperature has risen.

When the user changes to the deep sleep state, the processor 320 may determine whether the user's physical ecology has changed by operating the sensor module 176 (e.g., sensor circuit). For example, the processor 320 may determine whether the user sweating has increased or whether the user's body temperature has risen.

In operation 2540, according to an embodiment, if the user's sweating increases and body temperature rises, the electronic device 200 may adjust the fit to be loose such that the sweat may evaporate and the body temperature may drop.

According to an embodiment, if the user's sweating increases and body temperature rises, the processor 320 may adjust the fit to be loose such that the sweat may evaporate and the body temperature may drop.

In operation 2545, according to an embodiment, the electronic device 200 may identify whether the user's wake-up time is imminent. For example, the electronic device 200 may identify whether the set wake-up time or alarm time, to identify whether the wake-up time is imminent.

According to an embodiment, the processor 320 may identify whether the user's wake-up time is imminent. For example, the processor 320 may identify whether the set wake-up time or alarm time, to identify whether the wake-up time is imminent.

In operation 2550, according to an embodiment, the electronic device 200 may determine whether the user is in a light sleep state although the wake-up time is imminent.

The processor 320 may determine whether the user is in the light sleep state although the wake-up time is imminent.

In operation 2555, according to an embodiment, when the user is in the light sleep state, the electronic device 200 may adjust the fit to be tight such that the user may wake up from the light sleep state.

According to an embodiment, when the user is in the light sleep state, the processor 320 may adjust the fit to be tight such that the user may wake up from the light sleep state.

In operation 2560, according to an embodiment, the electronic device 200 may determine whether the user is in the deep sleep state although the wake-up time is imminent.

According to another embodiment, the processor 320 may determine whether the user is in the deep sleep state although the wake-up time is imminent.

In operation 2565, according to an embodiment, when the user is in the deep sleep state, the electronic device 200 may adjust the fit to be loose to prevent the user from waking from the deep sleep stage.

According to an embodiment, when the user is in the deep sleep state, the processor 320 may adjust the fit to be loose to prevent the user from waking from the deep sleep stage.

A wearable electronic device (e.g., wearable electronic device 200 of FIGS. 2A, 2B, 3A, and 3B) according to an embodiment of the disclosure may include a housing (e.g., housing 210 of FIG. 2A) including a first housing structure (e.g., first housing structure 211 of FIG. 2A), a second housing structure (e.g., second housing structure 212 of FIG. 2A) connected to the first housing structure 211), and a third housing structure (e.g., third housing structure 213 of FIG. 2A); a first hinge driving module (e.g., first hinge driving module 231 of FIG. 3B) configured to connect the first side of the first housing structure 211 and the second housing structure 212 such that the first housing structure 211 and the second housing structure 212 are folded and unfolded; a second hinge driving module (e.g., second hinge driving module 232 of FIG. 3B) configured to connect the second side of the first housing structure 211 and the third housing structure 213 such that the first housing structure 211 and the third housing structure 213 are folded and unfolded; a hinge driving unit (e.g., hinge driving unit 340 of FIG. 3A) configured to drive the first hinge driving module 231 and the second hinge driving module 232; a display (e.g., display 220 of FIG. 2A) arranged in the housing 210; a sensor module (e.g., sensor module 176 of FIG. 3A) configured to sense the angle between the housing structures (211, 212, 213), and to sense the bending curvature of the display 220; memory (e.g., memory 330 of FIG. 3A) including at least one storage medium that stores instructions; and at least one processor (e.g., processor 320 of FIG. 3A) including a processing circuit. When the instructions are executed individually or collectively by the at least one processor 320, the wearable electronic device 200 may detect a state in which the wearable electronic device 200 is worn on the wrist of the user using the sensor module 176.

When the instructions are executed individually or collectively by the at least one processor 320, the wearable electronic device 200 may identify the activity state of the user using the sensor module 176 based on detecting the state in which it is worn on the wrist of the user. When the instructions are executed individually or collectively by the at least one processor 320, the wearable electronic device 200 may adjust at least one of the angle between the housing structures (211, 212, 213) and the bending curvature of the display 220 based on the change in the activity state of the user.

According to an embodiment, when the instructions are executed by the at least one processor 320, the wearable electronic device 200 may adjust the angle between the first housing structure 211 and the second housing structure 212 by driving the first hinge driving module 231. When the instructions are executed by the at least one processor 320, the wearable electronic device 200 may adjust the angle between the first housing structure 211 and the third housing structure 213 by driving the second hinge driving module 232.

The display 220 may include the first display 221, the second display 222 arranged on the first side of the first display 221, and the third display 223 arranged on the second side of the first display 221. The second housing structure 212 may include the first curvature adjustment module 371 configured to adjust the bending curvature of the second display. The third housing structure 213 may include the second curvature adjustment module 372 configured to adjust the bending curvature of the third display. When the instructions are executed by the at least one processor 320, the wearable electronic device 200 may adjust the bending curvature of the second display 222 and the third display 223 using the first curvature adjustment module 371 and the second curvature adjustment module 372 based on the change in the activity state of the user.

According to an embodiment, the first display 221 may be arranged to be supported by the first housing structure 211. The second display 222 may be arranged to be supported by the second housing structure 212. The third display 223 may be arranged to be supported by the third housing structure 213.

According to another embodiment, the display 220 may include the first display 221, the second display 222 arranged adjacent to the first side of the first display 221, and the third display 223 arranged adjacent to the first display 221. When the instructions are executed by the at least one processor 320, the wearable electronic device 200 may adjust the bending curvature of the second display 222 and the third display 223.

According to an embodiment, the first display 221 may be arranged to be supported by the first housing structure 211. The second display 222 may be arranged to be supported by the second housing structure 212. The third display 223 may be arranged to be supported by the third housing structure 213.

According to an embodiment, when the instructions are executed by the at least one processor 320, the wearable electronic device 200 may sense the movement of the wearable electronic device 200 by operating the sensor module 176. When the instructions are executed by the at least one processor 320, the wearable electronic device 200 may determine the activity state of the user based on the movement sensing result of the wearable electronic device 200. When the instructions are executed by the at least one processor 320, the wearable electronic device 200 may adjust at least one of the angle of the hinge and the bending curvature of the display based on the activity state of the user.

When the instructions are executed by the at least one processor 320, the wearable electronic device 200, when the user activity state is a first state, may adjust the first housing structure 211 and the second housing structure 212 to form a first angle by driving the first hinge driving module 231, and may adjust the first housing structure 211 and the third housing structure 213 to form a first angle by driving the second hinge driving module 232.

According to an embodiment, when the instructions are executed by the at least one processor 320, the wearable electronic device 200, when the user activity state of the user is the first state, may adjust the second display 222 and the third display 223 to form a first bending curvature.

According to an embodiment, when the instructions are executed by the at least one processor 320, the wearable electronic device 200, when the activity state of the user is a second state with more movement than the first state, may adjust the first housing structure 211 and the second housing structure 212 to form a second angle smaller than the first angle by driving the first hinge driving module 231, and may adjust the first housing structure 211 and the third housing structure 213 to form a second angle smaller than the first angle by driving the second hinge driving module 232.

According to an embodiment, when the instructions are executed by the at least one processor 320, the wearable electronic device 200, when the activity state of the user is a second state with more movement than the first state, may adjust the second display 222 and the third display 223 to form a second bending curvature smaller than the first bending curvature.

According to another embodiment, when the instructions are executed by the at least one processor 320, the wearable electronic device 200, when the activity state of the user is a third state with less movement than the first state, may adjust the first housing structure 211 and the second housing structure 212 to form a third angle greater than the first angle by driving the first hinge driving module 231, and may adjust the first housing structure 211 and the third housing structure 213 to form a third angle greater than the first angle by driving the second hinge driving module 232.

According to an embodiment, when the instructions are executed by the at least one processor 320, the wearable electronic device 200, when the activity state of the user is a third state with less movement than the first state, may adjust the second display 222 and the third display 223 to form a third bending curvature greater than the first bending curvature.

According to an embodiment, when the instructions are executed by the processor 320, the wearable electronic device 200 may sense the humidity around the wearable electronic device 200 by operating the sensor module 176. When the instructions are executed by the processor 320, the wearable electronic device 200 may adjust at least one of folding or unfolding of the housing 210 and the bending curvature of the display 220 based on the result of sensing humidity around the wearable electronic device 200. The wearable electronic device 200 may be adjusted to be tightened on the wrist, or the wearable electronic device 200 may be adjusted to be loosened on the wrist.

According to an embodiment, when the instructions are executed by the processor 320, the wearable electronic device 200 may display, on the display, a first user interface indicating a tightening state of the wearable electronic device 200 on the wrist of the user.

According to an embodiment, when the instructions are executed by the processor 320, the wearable electronic device 200 may display, on the display, a second user interface indicating an operation of adjusting the wearable electronic device 200 to be tightened on the wrist of the user or an operation of adjusting the wearable electronic device 200 to be loosened on the wrist of the user.

When the instructions are executed by the processor 320, the wearable electronic device 200 may display, on the display, a third user interface for adjusting the first angle and the first bending curvature to a first fine value in a state in which the housing 210 forms the first angle and the display 220 forms the first bending curvature.

According to an embodiment, when the instructions are executed by the processor 320, the wearable electronic device 200 may display, on the display, a fourth interface indicating a state in which the housing 210 forms the second angle. When the instructions are executed by the processor 320, the wearable electronic device 200 may display, on the display, the fourth user interface for adjusting the second angle and the second bending curvature to a second fine value in a state in which the display 220 forms the second bending curvature.

According to an embodiment, when the instructions are executed by the processor 320, the wearable electronic device 200 may display, on the display, a fifth user interface indicating a state in which the housing 210 forms the third angle. When the instructions are executed by the processor 320, the wearable electronic device 200 may display, on the display, the fifth user interface for adjusting the third angle and the third bending curvature to a third fine value in a state in which the display 220 forms the third bending curvature.

According to another embodiment, when the instructions are executed by the processor 320, the wearable electronic device 200 may store at least one of the first fine value, the second fine value, and the third fine value in the memory 330. When the instructions are executed by the processor 320, the wearable electronic device 200 may apply at least one fine value suitable for the user's condition among the first fine value, the second fine value, and the third fine value in the memory 330.

In an operating method of the wearable electronic device 200 according to an embodiment of the disclosure, the wearable electronic device 200 may include the housing 210 including the first housing structure 211, the second housing structure 212 connected to the first housing structure 211, and the third housing structure 213; the display 220 arranged in the housing 210; the sensor module 176 configured to sense the angle between structures of the housing 210 and to sense the bending curvature of the display 220; the memory 330 including at least one storage medium that stores instructions; and at least one processor 320 including a processing circuit. The operating method, when the instructions are executed by the at least one processor 320, may cause the wearable electronic device 200 to detect a state in which the wearable electronic device 200 is worn on the wrist of the user using the sensor module 176. The operating method, when the instructions are executed by the at least one processor 320, may cause the wearable electronic device 200 to identify the activity state of the user using the sensor module 176 based on detecting the state in which it is worn on the wrist of the user. The operating method, when the instructions are executed by the at least one processor 320, may cause the wearable electronic device 200 to adjust at least one of the angle between the housing structures (211, 212, 213) and the bending curvature of the display 220 based on the change in the activity state of the user.

A recording medium according to an embodiment of the disclosure may store instructions readable by at least one processor of the wearable electronic device 200. The instructions, when executed by the at least one processor, may cause the wearable electronic device 200 to detect a state in which the wearable electronic device 200 is worn on the wrist of the user using the sensor module 176. The instructions, when executed by the at least one processor, may cause the wearable electronic device 200 to identify the activity state of the user using the sensor module 176 based on detecting the state in which the wearable electronic device 200 is worn on the wrist of the user. The instructions, when executed by the at least one processor, may cause the wearable electronic device 200 to perform an operation of adjusting at least one of the angle between the housing structures (211, 212, 213) and the bending curvature of the display 220 based on the change in the activity state of the user.

A wearable electronic device and an operating method thereof according to an embodiment of the disclosure may adjust the fit of an electronic device (e.g., wearable electronic device, smart watch, smart band) to be loosened or tightened (e.g., tight) according to the user's activity state (e.g., sleep, rest, exercise, swimming) and external environmental conditions (e.g., temperature, humidity).

A wearable electronic device and an operating method thereof according to an embodiment of the disclosure may display a user interface (e.g., content) on a display such that a user may intuitively recognize that the fit of an electronic device (e.g., wearable electronic device, smart watch, smart band) is adjusted.

A wearable electronic device and an operating method thereof according to an embodiment of the disclosure may provide a function capable of adjusting the fit of an electronic device (e.g., wearable electronic device, smart watch, smart band) to a default value and then fine-adjusting the fit according to the needs of the user.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing including a first housing structure, a second housing structure connected to the first housing structure, and a third housing structure;
a first hinge driving module configured to connect a first side of the first housing structure and the second housing structure such that the first housing structure and the second housing structure are folded and unfolded;
a second hinge driving module configured to connect a second side of the first housing structure and the third housing structure such that the first housing structure and the third housing structure are folded and unfolded;
a hinge driving unit configured to drive the first hinge driving module and the second hinge driving module;
a display arranged in the housing;
a sensor module configured to sense an angle between housing structures and to sense a bending curvature of the display;
memory, comprising at least one storage media, storing instructions; and
at least one processor, including a processing circuit, communicatively coupled to the memory,
wherein the instructions, when executed by the at least one processor individually or collectively, cause the wearable electronic device to:
detect a state in which the wearable electronic device is worn on a wrist of a user using the sensor module,
identify an activity state of the user using the sensor module based on detecting the state in which the wearable electronic device is worn on the wrist of the user, and
adjust at least one of the angle between the housing structures and the bending curvature of the display based on a change in the activity state of the user.

2. The wearable electronic device of claim 1, wherein the instructions, when executed by the at least one processor individually or collectively, further cause the wearable electronic device to:
adjust the angle between the first housing structure and the second housing structure by driving the first hinge driving module, and
adjust the angle between the first housing structure and the third housing structure by driving the second hinge driving module.

3. The wearable electronic device of claim 2,
wherein the display includes a first display, a second display arranged on the first side of the first display, and a third display arranged on the second side of the first display,
wherein the second housing structure includes a first curvature adjustment module configured to adjust the bending curvature of the second display,
wherein the third housing structure includes a second curvature adjustment module configured to adjust the bending curvature of the third display, and
wherein the instructions, when executed by the at least one processor individually or collectively, further cause the wearable electronic device to:
adjust the bending curvature of the second display and the third display using the first curvature adjustment module and the second curvature adjustment module based on the change in the activity state of the user.

4. The wearable electronic device of claim 3,
wherein the first display is arranged to be supported by the first housing structure,
wherein the second display is arranged to be supported by the second housing structure, and
wherein the third display is arranged to be supported by the third housing structure.

5. The wearable electronic device of claim 4,
wherein the display includes a first display, a second display arranged adjacent to the first side of the first display, and a third display arranged adjacent to the second side of the first display, and
wherein the instructions, when executed by the at least one processor individually or collectively, further cause the wearable electronic device to adjust the bending curvature of the second display and the third display.

6. The wearable electronic device of claim 5,
wherein the first display is arranged to be supported by the first housing structure,
wherein the second display is arranged to be supported by the second housing structure, and
wherein the third display is arranged to be supported by the third housing structure.

7. The wearable electronic device of claim 6, wherein the instructions, when executed by the at least one processor individually or collectively, further cause the wearable electronic device to:
sense movement of the wearable electronic device by operating the sensor module,
determine the activity state of the user based on the movement sensing result of the wearable electronic device, and
adjust at least one of the angle of a hinge and the bending curvature of the display based on the activity state of the user.

8. The wearable electronic device of claim 7, wherein the instructions, when executed by the at least one processor individually or collectively, further cause the wearable electronic device to:
when the activity state of the user is a first state, adjust the first housing structure and the second housing structure to form a first angle by driving the first hinge driving module, and
adjust the first housing structure and the third housing structure to form a first angle by driving the second hinge driving module.

9. The wearable electronic device of claim 8, wherein the instructions, when executed by the at least one processor individually or collectively, further cause the wearable electronic device to:
when the activity state of the user is a first state, adjust the second display and the third display to form a first bending curvature.

10. The wearable electronic device of claim 9, wherein the instructions, when executed by the at least one processor individually or collectively, further cause the wearable electronic device to:
when the activity state of the user is a second state with more movement than the first state, adjust the first housing structure and the second housing structure to form a second angle smaller than the first angle by driving the first hinge driving module, and
adjust the first housing structure and the third housing structure to form a second angle smaller than the first angle by driving the second hinge driving module.

11. The wearable electronic device of claim 10, wherein the instructions, when executed by the at least one processor individually or collectively, further cause the wearable electronic device to:
when the activity state of the user is a second state with more movement than the first state, adjust the second display and the third display to form a second bending curvature smaller than the first bending curvature.

12. The wearable electronic device of claim 11, wherein the instructions, when executed by the at least one processor individually or collectively, further cause the wearable electronic device to:
when the activity state of the user is a third state with less movement than the first state, adjust the first housing structure and the second housing structure to form a third angle greater than the first angle by driving the first hinge driving module, and
adjust the first housing structure and the third housing structure to form a third angle greater than the first angle by driving the second hinge driving module.

13. The wearable electronic device of claim 12, wherein the instructions, when executed by the at least one processor individually or collectively, further cause the wearable electronic device to:
when the activity state of the user is a third state with less movement than the first state, adjust the second display and the third display to form a third bending curvature greater than the first bending curvature.

14. A method of operating a wearable electronic device, the method comprising:
detecting a state in which the wearable electronic device is worn on a wrist of a user using a sensor module;
identifying an activity state of the user using the sensor module based on detecting the state in which the wearable electronic device is worn on the wrist of the user; and
adjusting at least one of an angle between housing structures and a bending curvature of a display based on a change in the activity state of the user.

15. The method of claim 14, further comprising:
adjusting the angle between a first housing structure and a second housing structure by driving a first hinge driving module; and
adjusting the angle between the first housing structure and a third housing structure by driving a second hinge driving module.

16. The method of claim 15,
wherein the display includes a first display, a second display arranged on a first side of the first display, and a third display arranged on a second side of the first display,
wherein the second housing structure includes a first curvature adjustment module configured to adjust the bending curvature of the second display,
wherein the third housing structure includes a second curvature adjustment module configured to adjust the bending curvature of the third display, and
wherein the method further comprises adjusting the bending curvature of a second display and a third display using the first curvature adjustment module and the second curvature adjustment module based on the change in the activity state of the user.

17. The method of claim 16,
wherein the display includes a first display, a second display arranged adjacent to the first side of the first display, and a third display arranged adjacent to the second side of the first display, and
wherein the method further comprises adjusting the bending curvature of the second display and the third display.

18. The method of claim 17, further comprising:
sensing movement of the wearable electronic device by operating the sensor module;
determining the activity state of the user based on the movement sensing result of the wearable electronic device; and
adjusting at least one of the angle of a hinge and the bending curvature of the display based on the activity state of the user.

19. One or more non-transitory computer-readable storage media storing one or more computer programs including computer-executable instructions that, when executed by at least one processor of a wearable electronic device individually or collectively, cause the wearable electronic device to perform operations, the operations comprising:
detecting a state in which the wearable electronic device is worn on a wrist of a user using a sensor module;
identifying an activity state of the user using the sensor module based on detecting the state in which the wearable electronic device is worn on the wrist of the user; and
adjusting at least one of an angle between housing structures and a bending curvature of a display based on a change in the activity state of the user.

20. The one or more non-transitory computer-readable storage media of claim 19, the operations further comprising:
adjusting the angle between a first housing structure and a second housing structure by driving a first hinge driving module; and
adjusting the angle between the first housing structure and a third housing structure by driving a second hinge driving module.
